(19) United States
(12) Patent Application Publication
(10) Pub. No.: US 2014/0190709 A1
(43) Pub. Date: Jul. 10, 2014

(54) Smoke or Fire Protection Device

(71) Applicant: STOEBICH BRANDSCHUTZ GMBH, Gostar (DE)

(72) Inventors: Jochen Stoebich, Langelsheim (DE); Stefan Siller, Lutter am Barenberge (DE); Frank Krueger, Bad Harzburg (DE); Robert Knein-Linz, Herzogenrath (DE)

(73) Assignee: STOEBICH BRANDSCHUTZ GMBH, Goslar (DE)

(21) Appl. No.: 13/804,451

(22) Filed: Mar. 14, 2013

Related U.S. Application Data
(63) Continuation-in-part of application No. 13/738,431, filed on Jan. 10, 2013.
Application No. 13/738,431 is a continuation-in-part of application No. 13/738,806, filed on Jan. 10, 2013.

(51) Int. Cl. A62C 2/10

(52) U.S. Cl. CPC A62C 2/10
USPC 169/48

(57) ABSTRACT

A smoke or fire protection device securely seals an opening for limiting the spread of fire and smoke through the opening of a building. A sealing lip and flexible ballast arranged at the foot of the opening of the building such that a flexible protection element is situated on the ground when the device is deployed to the protection arrangement. A locking device to lock a rod in an activated position when the device is deployed to said protection arrangement. The flexible protection element configured in a variety of arrangements using various materials and numerous construction methods. A lead guide for the device improves the resistance of the flexible protection member to forces exerted thereon. As such, the device may have certain advantages in limiting the spread of fire and smoke while resisting external forces and retaining mechanical strength and stability sufficient to pass the Hose Stream Test.

### CROSS REFERENCE TO RELATED APPLICATIONS

This application claims the benefit of priority to and incorporates herein by this reference in their entirety, U.S. patent application Ser. No. 13/738,431, entitled “Smoke or fire protection device” and filed on Jan. 10, 2013, and U.S. patent application Ser. No. 13/738,806, entitled “Lead System for a Fire and Smoke Protection Device” and filed on Jan. 10, 2013.

### BACKGROUND OF THE INVENTION

Fires within building structures often start in a single room or location and spread from room-to-room traveling through interior doorways and other openings. As fires progress through building structures burning various combustible materials, a substantial amount of smoke is generally produced with such smoke potentially including toxic gases that are generated when certain materials and chemical compounds are oxidized. While the fires can cause significant property damage and destroy or weaken building structures, the smoke and toxic gases can cause substantial physical injury or death to persons who inhale them. Thus, by limiting the spread of fires and smoke within building structures, damage to property and building structures may be minimized and physical injury to, and the potential death of, persons within building structures may be prevented.

Many attempts have been made to develop devices that limit the spread of fire and smoke through doorways and other openings in building structures. Unfortunately, many of the devices have been found to become mechanically unstable after a fire. Therefore, a number of jurisdictions have begun requiring such devices to pass a test known as the “Hose Stream Test” in order to be approved for use in their jurisdiction. The Hose Stream Test is generally run on a device for limiting the spread of fire and smoke after it has been exposed to high temperatures over a long period of time during a separate fire test. In the Hose Stream Test, a jet of water such as that produced by a fire hose is directed at the device, generally, from a direction that is normal to the device. To pass the Hose Stream Test, the device must withstand the forces exerted on the device by the water jet and not become mechanically unstable.

Typically, the devices that have been developed to limit the spread of fire and smoke fall into two categories. A first type of devices has attempted to limit the spread of fire and smoke by sealing openings with flexible protection elements including a plurality of slats. Examples of such devices include fire protection roller shutters, fire doors, and curtains made of metal components that slide over and relative to one another. Advantageously, these devices limit the spread of fire and smoke while being capable of withstanding mechanical loads particularly well, including after exposure to fire. As a consequence, many such devices have passed the Hose Stream Test. Unfortunately, these devices are typically heavy and require a large amount of space.

A second type of devices has attempted to limit the spread of fire and smoke by sealing openings with a flexible protection element manufactured from a fire resistant material that can be wound around a reel or winding shaft. The fire resistant materials used in such devices typically include woven textile fabrics having warp and weft threads. Beneficially, these devices reduce the spread of fire and smoke, are relatively light in weight, and save space. However, these devices are generally less resistant to mechanical influences and loads than devices of the first type described above. Consequentially, many of these devices cannot pass the Hose Stream Test.

The foot area, which is the area in which a flexible protection element meets the floor, has proven to be a weak point of such devices. Currently, known fire protection devices have a bottom rail which is generally constructed as a profiled metal sheet; however, the bottom rail can become distorted after a fire allowing the jet of extinguishing water to get through, which is not permissible in the Hose Stream Test.

There is, therefore, a need in the art for a fire or smoke protection system that limits the spread of fire and smoke through openings in building structures, securely seals a foot area, is lightweight, requires minimal space, is capable of withstanding mechanical loads during and after exposure to fire, is capable of passing the Hose Stream Test, and that solves the difficulties, problems, and shortcomings of existing systems.

### SUMMARY OF THE INVENTION

The present invention relates, generally, to the field of systems, including devices and methods, for limiting the spread of fire and smoke in a building structure. The present invention comprises a fire and smoke protection system, including devices and methods, for limiting the spread of fire and smoke through an opening of a building. In a plurality of example embodiments described herein, the fire and smoke protection system comprises multiple components that may be selectively included, constructed and configured to meet the requirements of particular applications and of the Hose Stream Test. For example, the various components of the fire and smoke protection system include a flexible protection element that is configurable to retract into a storage arrangement and for subsequent deployment into a protection arrangement in the event of a fire.

The flexible protection element may be configured in a variety of configurations using a variety of materials, alone or in combination, and using a variety of construction methods. Generally and without limitation, the flexible protection element may be manufactured using fire resistant woven and knitted fabric elements, metal foil elements, intumescent elements, and/or wire mesh elements in many different arrangements, including multi-layer structures, with each material, element and arrangement having certain advantages in limiting the spread of fire and smoke while resisting external forces and retaining mechanical strength and stability sufficient to pass the Hose Stream Test.

In an exemplary embodiment, a flexible protection element may comprise a multi-layer structure including a metal foil element sandwiched between two woven fabric elements with the multi-layer structure being surrounded in the lateral and longitudinal directions by a single layer, knitted fabric element. Advantageously, when deployed, the multi-layer structure provides resistance to the spread of fire and smoke, while the knitted fabric elements stretch to enable the flexible protection element to withstand forces acting on it during a fire, including those forces nearest the edges of the flexible protection member which may have the greatest magnitude.

In another exemplary embodiment, a flexible protection element may be similar to the above-described flexible protection element, but include a segment of the knitted fabric element above the multi-layer structure formed with a gathering or overlap of material held in position with seams having non-fire resistant thread. Upon exposure to fire, the seams are destroyed or come undone, thereby permitting the gathered and overlapping knitted fabric segment to become non-gathered, providing more knitted fabric material available to stretch upon the application of forces thereto, and producing more surface area normal to the forces and distributing the forces over the greater surface area.

In yet another exemplary embodiment, a flexible protection element may be constructed using seams between fabric and metal foil members that are formed with stitching patterns and/or stitching arrangements that are more flexible and stretchable than other types of stitching patterns and stitching arrangements. Through the use of such flexible stitching patterns and/or stitching arrangements, the flexible protection member includes seams with improved flexibility and stretchability that contribute to the overall ability of the flexible protection member to flex, deform, and stretch in response to forces being applied to the flexible protection element.

In still another exemplary embodiment, a flexible protection element may be manufactured with a metal foil element imprinted or embossed with a pattern. Subsequently, when exposed to a force at particular location, the imprinted or embossed material in the vicinity of the force location deforms in order to resist the force and oppose tearing of the flexible protection element.

In yet another exemplary embodiment, a flexible protection element is formed from a plurality of transverse strips such that adjacent strips are coupled together by a clamping member. Each transverse strip is, generally, made from one or more materials and/or one or more layers of materials that are configured in a desired arrangement similar to the manner in which a flexible protection element having a single strip might be configured and constructed. Generally, each transverse strip is identical to the other transverse strips of the flexible protection element, but may include one or more different materials, layers or structures such that segments near the mid-section of the flexible protection element, for example, may have different mechanical and fire resistant properties than strips nearer the other sections of the flexible protection element. Each clamping member is selected from a plurality of different types of clamping members, some of which are described herein. Typically, the clamping members are of the same type and extend beyond the appropriate extent of the flexible protection element into the device's lead tracks to improve deployment and retraction of the flexible protection member, but may comprise individually different types of clamps and may not all similarly extend into the device's lead tracks. Advantageously, the clamping members add mechanical strength and stability to the flexible protection element, reduce sagging of the flexible protection element during exposure to fire or high temperatures, improve deployment and retraction of the flexible protection member by virtue of one or more of the clamping members extending into the device's tracks, and aid the flexible protection element in passing the Hose Stream Test.

Further, the present invention relates to a smoke or fire protection device may include a sealing lip attached to the flexible protection element at the foot of the opening of the building such that the flexible protection element is situated on the ground when deployed to the protection arrangement. To improve the seal of the system at the foot of the opening, a flexible ballast may be arranged on the sealing lip to securely seal the flexible protection element relative to the ground and the underside of the flexible protection element.

In another exemplary embodiment, a smoke or fire protection device may include a locking device to lock a rod in an activated position when the system is deployed to said protection arrangement. To ensure a secure seal at the foot of the opening, the locking device may have a heat-activated element configured to position a bar into the activated position if an activation temperature is exceeded.

In addition, by way of example and not limitation, the present invention may comprise a lead guide for a smoke or fire protection device, including apparatuses and methods that enable the deployment and retraction of a flexible protection element relative to an opening in a wall and that improves the resistance of the flexible protection member to forces exerted thereon. According to exemplary embodiments, the lead guide comprises a pair of opposed, lead tracks for guiding a flexible protection member between a retracted, storage arrangement and a fully-deployed, protection arrangement, for permitting the flexible protection element to stretch and bulge when a force is applied to the flexible protection element, and for transferring forces to the building to which the lead tracks are secured.

### BRIEF DESCRIPTION OF THE DRAWINGS

FIG. 1 illustrates a schematic, front elevational view of a smoke or fire protection device in accordance with an exemplary embodiment of the present invention.

FIG. 2A shows a schematic of a partial isometric view of a smoke or fire protection device in an unlocked position in accordance with an embodiment of this invention.

FIG. 2B a schematic of a partial isometric view of a smoke or fire protection device in the activated position in accordance with an embodiment of this invention.

FIG. 3 is a detailed view of an alternative exemplary embodiment according to the present invention.

FIG. 4 is a cross-sectional view of alternative exemplary embodiment according to the present invention.

FIG. 5A depicts a schematic of a locking device and a bar in an unlocked position.

FIG. 5B illustrates a schematic of a locking device and a bar in an activated position.

FIG. 6 displays a schematic, front elevational view of a smoke or fire protection device, in accordance with an example embodiment, for substantially sealing an opening in a building structure and limiting the spread of fire and smoke through the opening during a fire.

FIG. 7A displays a schematic, front elevational view of a flexible protection element of the smoke or fire protection device of FIG. 6.

FIG. 7B displays a schematic, bottom plan view of a flexible protection element of the smoke or fire protection device of FIG. 6.

FIG. 7C displays a schematic, partial back elevational view of a flexible protection element of the smoke or fire protection device of FIG. 6.

FIG. 8A displays a schematic, bottom plan view of a flexible protection element of a smoke or fire protection device in accordance with an example embodiment.

FIG. 8B displays a schematic, partial back elevational view of a flexible protection element of a smoke or fire protection device in accordance with an example embodiment.

FIG. 9A displays a schematic, bottom plan view of a flexible protection element of a smoke or fire protection device in accordance with an example embodiment.

FIG. 9B displays a schematic, partial back elevational view of a flexible protection element of a smoke or fire protection device in accordance with an example embodiment.

FIG. 10A displays a schematic, front elevational view of a flexible protection element of a smoke or fire protection device in accordance with an example embodiment.

FIG. 10B displays a schematic, bottom plan view of a flexible protection element of a smoke or fire protection device in accordance with an example embodiment.

FIG. 10C displays a schematic, partial back elevational view of a flexible protection element of a smoke or fire protection device in accordance with an example embodiment.

FIG. 11A displays a schematic, cross-sectional view of a seam of a multi-layer flexible protection element of a smoke or fire protection device, in accordance with an example embodiment, before exposure to fire.

FIG. 11B displays a schematic, cross-sectional view of a seam of a multi-layer flexible protection element of a smoke or fire protection device, in accordance with an example embodiment, after exposure to fire.

FIG. 12A displays a schematic, cross-sectional view of a seam of a multi-layer flexible protection element of a smoke or fire protection device, in accordance with an example embodiment, before exposure to fire.

FIG. 12B displays a schematic, cross-sectional view of a seam of a multi-layer flexible protection element of a smoke or fire protection device, in accordance with an example embodiment, after exposure to fire.

FIG. 13 displays a schematic, front elevational view of a smoke or fire protection device, in accordance with an example embodiment, for substantially sealing an opening in a building structure and limiting the spread of fire and smoke through the opening during a fire.

FIG. 14 displays a schematic, top plan view of a flexible protection element of a smoke or fire protection device in accordance with an example embodiment.

FIG. 15 displays a schematic, top plan view of a flexible protection element of smoke or fire protection device in accordance with an example embodiment.

FIG. 16 displays a schematic, top plan view of a flexible protection element of a smoke or fire protection device in accordance with an example embodiment.

FIG. 17 displays a schematic, top plan view of a flexible protection element of a smoke or fire protection device in accordance with an example embodiment.

FIG. 18 displays a schematic, top plan view of a flexible protection element of a smoke or fire protection device in accordance with an example embodiment.

FIG. 19 displays a schematic, top plan view of a flexible protection element of a smoke or fire protection device in accordance with an example embodiment.

FIG. 20 displays a schematic, front perspective view of a flexible protection element of a smoke or fire protection device, in accordance with an example embodiment, in an opening through which the spread of fire and smoke is to be limited.

FIG. 21 displays a schematic, front perspective view of a flexible protection element of a smoke or fire protection device, in accordance with an example embodiment, in an opening through which the spread of fire and smoke is to be limited.

FIG. 22 displays a schematic, partial, front elevational view of a flexible protection element of a smoke or fire protection device having elongate clamping members in accordance with an example embodiment.

FIG. 23 displays a schematic, cross-sectional view of an elongate clamping member of the flexible protection element of FIG. 22 taken along lines 18-18 and showing portions of the adjacent transverse strips.

FIG. 24 displays a schematic, partial, front elevational view of a flexible protection element of a smoke or fire protection device having elongate clamping members in accordance with an example embodiment.

FIG. 25 displays a schematic, cross-sectional view of an elongate clamping member of the flexible protection element of FIG. 24 taken along lines 20-20 and showing portions of the adjacent transverse strips.

FIG. 26 displays a schematic, partial, front elevational view of a flexible protection element of a smoke or fire protection device having elongate clamping members in accordance with an example embodiment.

FIG. 27 displays a schematic, cross-sectional view of an elongate clamping member of the flexible protection element of FIG. 26 taken along lines 22-22 and showing portions of the adjacent transverse strips.

FIG. 28 displays a schematic, partial, front elevational view of a flexible protection element of a smoke or fire protection device having elongate clamping members in accordance with an example embodiment.

FIG. 29 displays a schematic, cross-sectional view of an elongate clamping member of the flexible protection element of FIG. 28 taken along lines 24-24 and showing portions of the adjacent transverse strips.

FIG. 30 displays a schematic, partial, front elevational view of a flexible protection element of a smoke or fire protection device having elongate clamping members in accordance with an example embodiment.

FIG. 31 displays a schematic, cross-sectional view of an elongate clamping member of the flexible protection element of FIG. 30 taken along lines 26-26 and showing portions of the adjacent transverse strips.

FIG. 32 displays a schematic, partial, front elevational view of a flexible protection element of a smoke or fire protection device having elongate clamping members in accordance with an example embodiment.

FIG. 33 displays a schematic, cross-sectional view of an elongate clamping member of the flexible protection element of FIG. 32 taken along lines 28-28 and showing the elongate clamping member in a closed configuration.

FIG. 34 displays a schematic, cross-sectional view of the elongate clamping member of FIG. 33 in an open configuration.

FIG. 35 displays a schematic, front elevational view of a flexible protection element of a smoke or fire protection device in accordance with an example embodiment, having a front surface imprinted or embossed with a pattern.

FIG. 36 displays a schematic, partial, front elevational view of a smoke or fire protection device, in accordance with an example embodiment, in which the flexible protection element is formed from a multi-layer structure including a metal foil element and multiple wire mesh elements.

FIG. 37 displays a schematic, partial, front elevational view of a smoke or fire protection device, in accordance with an example embodiment, in which the flexible protection element is formed from a multi-layer structure including multiple metal foil elements and multiple wire mesh elements.

FIG. 38 displays a schematic, partial diagram of a device, in accordance with an example embodiment, for manufacturing a multi-layer composite material for use in making a flexible protection element.

FIG. 39 displays a schematic, front, elevational view of a lead guide, in accordance with an example embodiment, for use with, or as a component part of, a smoke or fire protection device for substantially sealing an opening in a building structure and limiting the spread of fire and smoke through the opening during a fire.

FIG. 40 displays a partial, schematic, perspective view of a lead track of the lead guide of FIG. 39.

FIG. 41 displays a schematic, cross-sectional view of the lead track of FIG. 40 taken along lines 3-3.

FIG. 42 displays a schematic, cross-sectional view of a lead track, according to an alternate example embodiment, taken along similar lines as the cross-sectional view of FIG. 41.

FIG. 43 displays a partial, schematic, cross-sectional view of a lead track, according to an alternate example embodiment, showing the interaction between the lead track and transverse strips of a flexible protection element.

FIG. 44 displays a partial, schematic cross-sectional view of the lead track of FIG. 43 taken along lines 6-6.

### DETAILED DESCRIPTION OF THE INVENTION

It is understood that specific embodiments are provided as examples to teach the broader inventive concept, and one of ordinary skill in the art can easily apply the teachings of the present disclosure to other methods and systems. Also, it is understood that the various devices discussed in the present disclosure include some conventional structures. Since these structures are well known in the art, they will only be discussed in a general level of detail. Furthermore, reference numbers are repeated throughout the drawings for the sake of convenience and example, and such repetition does not indicate any required combination of features throughout the drawings.

### Ballast

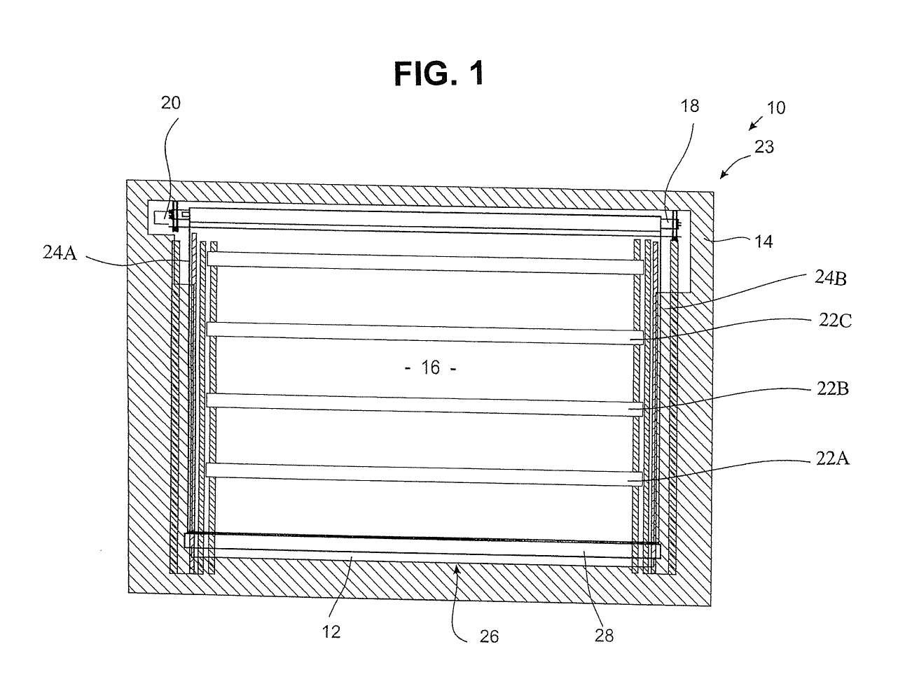

FIG. 1 illustrates a schematic front view of a smoke or fire protection device 10 (also sometimes referred to herein as the “device”) in accordance with an exemplary embodiment of the present invention. It should be noted that in FIG. 1, the cross-hatching is present to improve clarity and the differentiation of the various components the smoke or fire protection device 10, and does not, necessarily, signify a section through an object. The smoke or fire protection device 10 enables substantial sealing of an opening 12 in a building structure 14 and limiting of the spread of fire and smoke through the opening 12. The smoke or fire protection device 10 is adapted for secure connection to a wall of building structure 14 relative to the opening 12 and is configurable in a first configuration (also sometimes referred to herein as a “storage arrangement”) that permits ingress and egress through the opening 12 when no fire or smoke exists. The device 10 is also configurable in a second configuration (also sometimes referred to herein as a “fully-deployed configuration” or a “protection arrangement”) in which the device 10 significantly limits or prevents the spread of fire and smoke through the opening 12 during a fire.

Generally, the smoke or fire protection device 10 comprises a flexible protection element 16 and a winding shaft 18 about and onto which the flexible protection element 16 is fully-wound (and, hence, fully-retracted) when the device 10 is configured in the storage arrangement so as not to occlude and/or seal the opening 12. Conversely, the flexible protection element 16 is substantially fully-unwound from the winding shaft 18 when the device 10 is configured in the protection arrangement so that the flexible protection element 16 fully occludes and/or seals the opening 12. Thus, the flexible protection element 16 is selectively configurable to occlude or not occlude the opening 12.

The flexible protection element 16 includes a sheet-like member that is relatively thin in thickness as compared to the lateral and longitudinal dimensions thereof. For reference, the term “longitudinal” is used herein to refer to the direction in which the flexible protection element 16 is deployed or retracted, and frequently has its longest dimension. The term “lateral” is used herein to refer to the direction perpendicular to the longitudinal direction and in which the flexible protection element 16 often has its shortest dimension (other than its thickness).

The flexible protection element 16 may comprise a single layer of material, multiple layers of the same or different materials, and/or have adjoining portions comprising single or multiple layers of materials that are manufactured and arranged in various configurations to provide structural strength, stability, and resistance to forces applied during or shortly after exposure to high temperatures such as those that may be encountered with a fire. Typically, the flexible protection element 16 is manufactured using one or more fire resistant materials, including, without limitation, fire resistant woven and knitted fabric materials, metal foil materials, intumescent materials, and/or wire mesh materials. Possible different constructions of the flexible protection element 16 are described more fully below in the section entitled “Protection Element,” and is also detailed in U.S. patent application Ser. No. 13/738,431, entitled “Smoke or fire protection device” and filed on Jan. 10, 2013, which is incorporated in its entirety herein by reference.

The flexible protection element 16 also may comprise one or more laterally-extending transverse strips 22A, 22B, and 22C (also sometimes referred to collectively herein as reference number 22), with each transverse strip 22 being offset from the immediately preceding and succeeding transverse strips 22 in the longitudinal direction. The transverse strips 22 may be manufactured from stainless steel and may be designed as terminal strips. Each transverse strip 22 is connected to the material of the flexible protection element 16 and is received respectively within the lead guide 23. To stabilize the surface area of the flexible protection element 16, it is recommended that the flexible protection element 16 include at least one and, perhaps, a few laterally-extending transverse strips 22. As further discussed below, each transverse strip 22 may or may not comprise a clamping member, which is similar to those described in U.S. patent application Ser. No. 13/738,431.

Additionally, in the example embodiment, the flexible protection element 16 may comprise a sealing lip 28 arranged at and in contact with a foot 26 of the opening 12 when the device 10 is configured in the protection arrangement. The sealing lip 28 may be attached along the bottom edge of the flexible protection element 16 and is sufficiently heavy as to maintain the flexible protection element 16 pulled taut when the device 10 is not in the storage arrangement.

The fire or smoke protection device 10 also generally comprises a winding shaft motor 20 mechanically connected to the winding shaft 18 that is operable to rotate the winding shaft 18 in order to retract and wind the flexible protection element 16 onto the winding shaft 18, or to extend and unwind the flexible protection element 16 from the winding shaft 18. Through operation of the winding shaft motor 20, the device 10 may be additionally configured, generally temporarily, in a plurality of intermediate configurations such as the intermediate configuration illustrated in FIG. 1. As also seen in FIG. 1, the flexible protection element 16 is substantially unwound from the winding shaft 18 and extended to significantly, although not entirely, occlude the opening 12. In other intermediate configurations, the flexible protection element 16 is partially unwound from the winding shaft 18 and occludes the opening 12 to a lesser or greater extent.

As detailed below in the section entitled “Lead Guide,” the lead guide 23 of the example embodiment comprises a structure that is configured for cooperative operation with the fire and protection device 10 or, potentially, with other similar devices having similar flexible protection elements 16 to direct and guide a flexible protection element 16 during reconfiguration between a storage arrangement and a protection arrangement and to limit the spread of fire and smoke around the flexible protection element 16. Additionally, the lead guide 23 provides structural support for the flexible protection element 16 (which is generally not self-supporting) and resistance to forces applied to the flexible protection element 16 during a fire. According to the example embodiment, the lead guide 23 is adapted to guide a flexible protection element 16 on a pre-determined linear path. However, in other example embodiments, the lead guide 23 may be adapted to guide a flexible protection element 16 along a pre-determined non-linear path. In addition, possible different constructions of the lead guide 23 are described more fully in U.S. patent application Ser. No. 13/738,806, entitled “Lead System for a Fire and Smoke Protection Device” and filed on Jan. 10, 2013, which is incorporated in its entirety herein by reference.

In accordance with the example embodiment depicted in FIG. 1, the lead guide 23 comprises a first lead track 24A and an opposed second lead track 24B that are secured to the wall of the building 14 at respectively opposed locations relative to, in or near the opening 12. To integrate the lead guide 23 into the building 14 as unobtrusively as possible, the one or more tracks 24A, 24B are often mounted to the wall or embedded within the wall surrounding and forming the opening 12 through which the spread of fire and smoke is to be limited by the device 10. The flexible protection element 16 is respectively received by the lead tracks 24A, 24B during reconfiguration of the device 10 between the storage arrangement and protection arrangement and while the device 10 remains in the storage arrangement. In addition, the symmetrically constructed lead tracks 24A, 24B include guiding members as disclosed in greater detail below and in U.S. patent application Ser. No. 13/738,806.

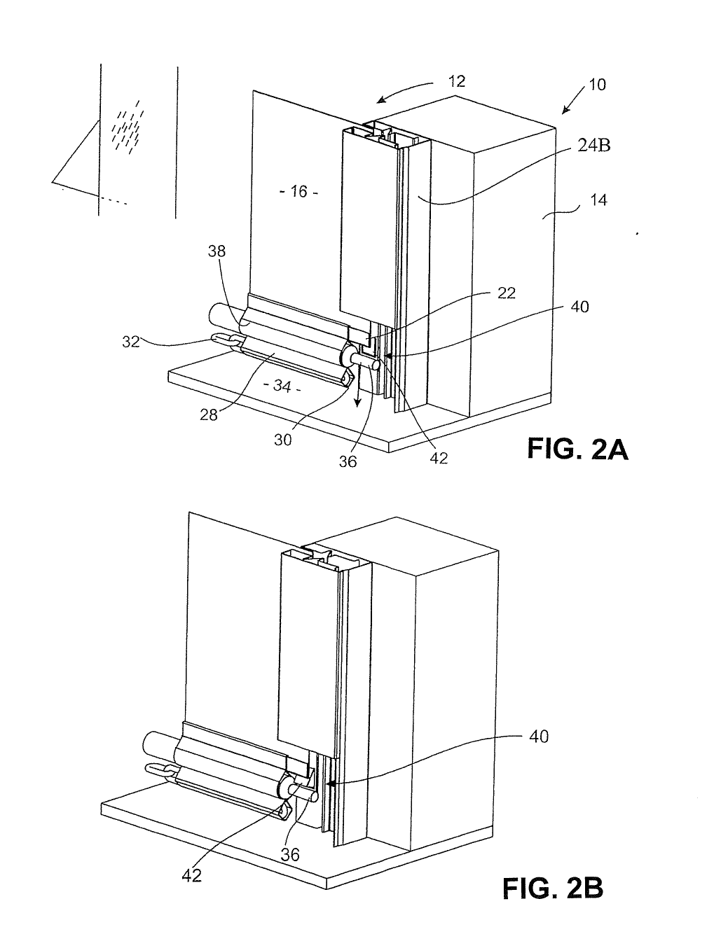

FIG. 2A shows a schematic of a partial isometric view of a smoke or fire protection device 10 in accordance with an embodiment of this invention in an unlocked position. For purposes of clarity, only the bottom terminal transverse strip 22A is depicted in FIGS. 2A and 2B. The sealing lip 28 includes a loop 30 in which a flexible ballast 32, as illustrated in the form of a chain, is arranged. The sealing lip 28 is arranged at a foot 26 of the opening 12. For example and not limitation, the chain may be formed of a heavy metal or ceramic, as long as its weight is sufficient to securely hold the flexible protection element 16 near the ground while in a protection arrangement.

The sealing lip 28 refers to, for example, an elongated element that may be distorted in such a way that it becomes wider when it touches the ground. A person of ordinary skill in the art would appreciate that the sealing lip 28 may also be referred to as sack-like or bag-like. For example, if the flexible ballast 32 is made from granulate the sealing lip 28 hangs loosely downwards in a sack or bag like manner. As soon as the sealing lip 28 meets the ground, the surface which touches the ground expands. The weight of the flexible ballast 32 results in a close contact between the flexible protection element 16 and the ground, preventing a jet of extinguishing water from passing through an underside 34.

The sealing lip 28 can be sealed on both sides, for example by stitching. However, for the sake of a better representation of the present invention, the sealing lip 28 is illustrated in the figures as unsealed.

The sealing lip 28 is preferably made of a flexible and fire resistant material. As used herein, the term “fire resistant material” refers to a material used to construct a component or object comprising a woven, non-woven or knitted fabric that is either non-flammable or has substantial resistance to burning. Fire resistant materials may include glass fibers, metal fibers, and/or wires. Typically, the woven and knitted fabrics of the example embodiments are selected to prevent a fire from spreading or delay the flow of smoke through an opening 102 for a desired, pre-determined amount of time such as, for example thirty (30), ninety (90) or one hundred and twenty (120) minutes and may, or may not, be selected in accordance with various fire codes issued by governmental agencies or standards bodies. A person of ordinary skill in the art would understand fire resistant material to mean an object constructed from fibers, such as a woven or non-woven fabric that is made of a non-flammable, fire resistant material. By way of example and not limitation, the fire resistant material comprises glass fibers, metal fibers, and/or wires.

Referring to FIG. 2A, while the flexible ballast 32 is illustrated as a chain, it is not necessary for the flexible ballast 32 to be a chain. By way of example and not limitation, the flexible ballast 32 may also be formed by a granulate-filled loop or by granulate alone. Further, other fillings are conceivable for the flexible ballast 32 as long as any fillings are sufficiently heavy and may adapt well to the underside 34 of the flexible protection element 16. The flexible ballast 32 generally stretches along the length of the sealing lip 28 and at least over 80% of the width of the flexible protection element 16. However, this stretching is not required, because it is also possible that the flexible ballast 32 runs over a smaller proportion of the length of the sealing lip 28. One advantage of making a flexible ballast 32 from granulate or several elements connected to each other (e.g., a chain) is that the flexible ballast 32 may adapt especially well to any uneven points on the ground, and thus the flexible ballast 32 is not able to transmit thrusts.

As seen in both FIGS. 2A and 2B, a rod 36 is arranged above the sealing lip 28, the rod 36 being incorporated in a bulge 38 or another loop of the flexible protection element 16, which results in a particularly secure hold for the rod 36. However, the connection of the rod 36, as well as the sealing lip 28, to the flexible protection element 16 is not limited to such a way, but, as an example and not limitation, may also be attached by means of clamps, which does not weaken the flexible protection element 16. A further non-limiting example for attaching the sealing lip 28 and/or the rod 36 to the flexible protection element 16 is by securely sewing the components to each other.

The flexible protection element 16 includes a rod 36 at the foot 26 of the opening 12, which is fixed onto the flexible protection element 16 above the sealing lip 28, so that the rod presses on the sealing lip 28 when the flexible protection element 16 is in its protection arrangement. The rod 36 may have a diameter of, for example, more than 15 mm, preferably 20 mm, and may be constructed of a fire-resistant material, such as stainless or non-stainless steel. This material has a relatively high density such that the rod 36 exerts a weight force (F_{g}) onto the sealing lip 28, which presses it hard onto the ground. In an alternative, the rod 36 is designed to be thinner and less stable, and the flexible ballast 32 may be designed to be heavier to compensate for the lighter rod 36, and thus still result in a secure sealing of the flexible protection element 16 relative to the underside 34 of the flexible protection element 16.

In one embodiment, the rod 36 may have a length-specific mass of at least 2.5 grams per millimeter, in particular, 5.5 grams per millimeter may be preferred. In such an embodiment, the rod 36 is heavy enough to exert such a large force on the sealing lip 28 that a jet of extinguishing water can be securely prevented from getting through in any circumstances. However, it is also possible to use lighter weighing rods to achieve the same results. For example, steel has been proven to be an advantageous material for the rod 36, because steel has a relatively high density and also good mechanical strength properties.

Further, to increase the likelihood that the rod 36 always optimally presses onto the sealing lip 28, it may be advantageous for the rod 36 to be guided into a lead 23 with one or more tracks (as seen in FIG. 1). Smoke or fire protection devices generally have side lead elements in order to ensure a secure opening and closing. As discussed above, the “Lead System” section provided below discloses an example of advantageously suitable lead for the present invention; see also U.S. patent application Ser. No. 13/738,806.

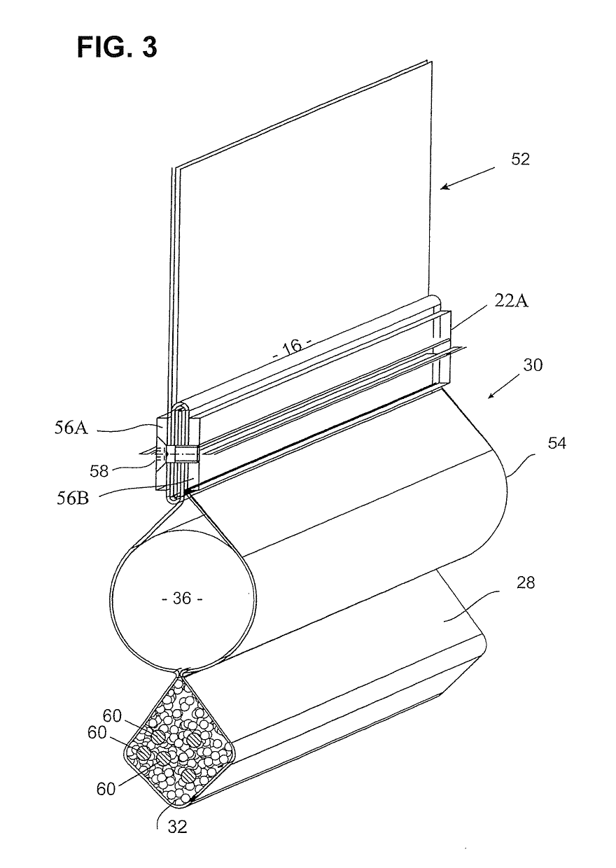

FIG. 3 is a detailed view of an alternative exemplary embodiment according to the present invention. FIG. 3 shows a sealing lip 28, a flexible ballast 32 (which is depicted to be made of an iron granulate as an example), a rod 36 and a flexible protection element 16. A person having ordinary skill in the art would recognize that the flexible protection element 16 is constructed from two modules that can be separated from one another, namely a first module 52 and a second module 54. Both modules 52, 54 are connected by the terminal transverse strip 22A, which includes two clamping rods 56A, 56B that are braced against one another by means of screws 58. Accordingly, the two modules 52, 54 may be connected to each other in such a way that a striking jet of extinguishing water does not lead to a tear in the connection.

Additionally, the sealing lip may also comprise an intumescent material 60. By way of example and not limitation, the intumescent material 60 of sealing lip 28 may refer to expandable graphite, which allows the sealing lip 28 to expand in the event of a fire. As used herein, the term intumescent refers to a material having a heat consuming, or endothermic, physical reaction or an endothermal chemical reaction when exposed to heat. An intumescent material, acceptable for use in the heat-activated element 46 in accordance the example embodiments herein, includes expandable graphite (i.e., expands when heated). In an alternative, the intumescent material includes a base layer of the flexible protection and is manufactured from a fire resistant material into the loops of which an intumescent material is incorporated. The fire resistant material may be manufactured from woven or knitted fabric, but it is advantageous if the fire resistant material comprises a knitted fabric as the knitted fabric yields if the intumescent material expands. Also, if the loops of the fire resistant material are made with both fire resistant threads and non-fire resistant threads, the loops made with non-fire resistant thread come undone upon exposure to fire, thereby causing the knitted fabric to have a larger surface area and giving the intumescent material more space to expand. Alternatively, the base layer includes a fire resistant material that is coated with an intumescent material. In other embodiments, the base layer may incorporate an intumescent material in a variety of other arrangements and manners, including those described in International Patent Application No. PCT/DE2008/000999 entitled “Fire-Resistant Closure” and filed on Jun. 19, 2008 (published as International Patent Application Publication No. WO 2008/154906 A1 on Dec. 24, 2008), which is incorporated in its entirety herein by reference.

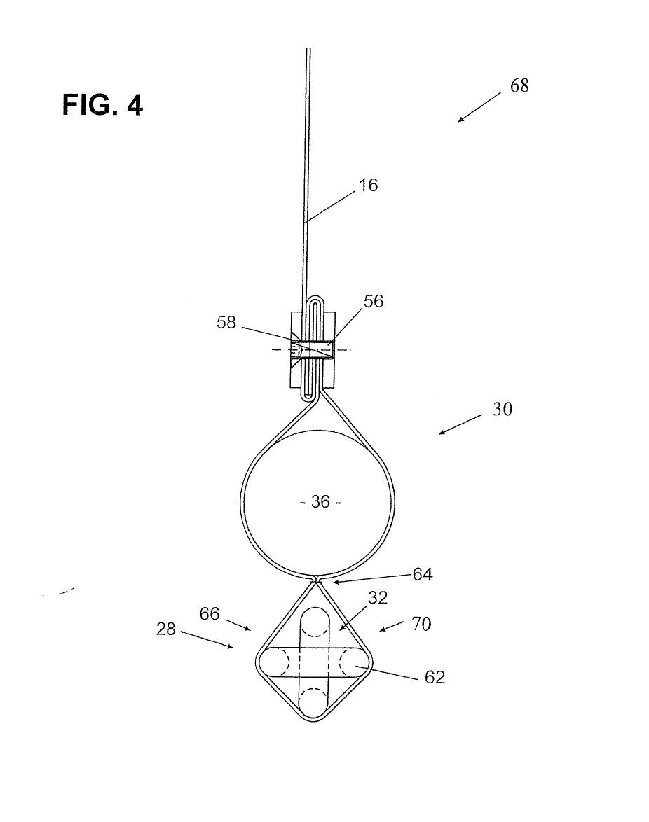

FIG. 4 is a cross-sectional view of alternative exemplary embodiment according to the present invention. The sealing lip 28 includes a chain 62 as the flexible ballast 32. The seam 64 is used to connect a first part 66 of the flexible protection element 16 to a second part 68 thus forming the loop 30 and a second loop 70. The first loop 30 holds the rod 36 and the second loop 70 holds the flexible ballast 32, which in this exemplary embodiment is shown as the chain 62. While FIG. 4 shows a device with two loops, a person having ordinary skill in the art would appreciate a device may have more than two loops. In addition, it would be understood by a person having ordinary skill in the art that the first loop 30 may include more than one rod 36 and/or additional material, such as granulate material.

### Locking Device

FIG. 2A also shows a locking device 40 that comprises a bar 42, depicted in non-activated or unlocked position. The bar 42 is configured to allow it to pivot. In the non-activated or unlocked position, the rod 36 may be moved in both directions past the bar 42, to permit closing and opening. In other words, the rod's 36 freedom of movement is not restricted.

In contrast to FIG. 2A, FIG. 2B a schematic of a partial isometric view of a smoke or fire protection device 10 in accordance with an embodiment of this invention in the activated or locked position. The bar 42 of locking device 40 is open and prevents the rod 36 from being moved upwards and restricting the freedom of movement of the rod 36. In the activated or locked position, it is not possible to move the flexible protection element 16 from its protection arrangement (as depicted in FIGS. 2A and 2B) into a storage arrangement. It may also be possible for the flexible protection element 16 to be in its protection arrangement without the locking device 40 being activated. In this case, it is possible to put the flexible protection element 16 back into the storage arrangement without any extra requirements, because the rod's 36 freedom of movement is not restricted.

Typically, the flexible protection element 16 closes from top to bottom, as illustrated in FIG. 1, the flexible protection element 16 is shown to deploy and retract in the vertical longitudinal direction. In this exemplary embodiment, the locking device 40 functions to restrict the upward movement of the rod 36. However, it should be understood and appreciated that the flexible protection element 16 may deploy and retract from bottom to top or from one side in a horizontal lateral direction. Nevertheless, depending on the opening/closing motion of the flexible protection element 16, the locking device 40 may prevent the rod 36 from moving in the direction that would cause the flexible protection element 16 to retract into the storage arrangement. One advantage of the locking device 40 is that it guarantees that the flexible protection element 16 will securely seal the opening 12 in the event of a fire. Even if components of the smoke or protection device 10 warp as a result of the heat from the fire, the locking device 40 always ensures that the rod 36 remains fixed close to the ground and that the opening 12 is sealed securely.

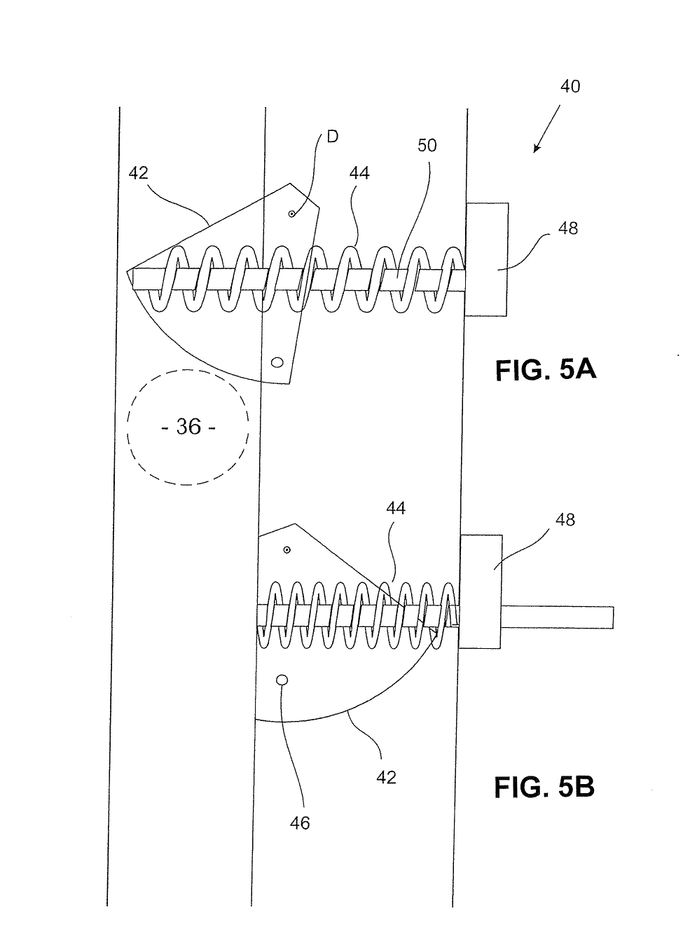

FIG. 5A depicts a schematic of the locking device 40 and bar 42 in an inactive state or an unlocked position. The functionality of a smoke or fire protection device 10 is tested on a regular basis. For testing the device's 10 functionality, it is repeatedly deployed and retracted. Accordingly, it may be advantageous that the deployment and retraction for the purpose of testing is accomplished with ease, while not hindering the safe operation of the device 10 in the event of a fire. Therefore, it may be advantageous if the locking device 40 includes a bar 42 and a heat-activated element 46 that has an activation temperature. The bar 42 is configurable to be in a locked position, in which the rod 36 is locked, and a release position or unlocked position, in which the rod 36 is unlocked. The heat-activated element 46 is arranged in such that it positions the bar 42 in the locking position if the activation temperature is exceeded. By way of example and not limitation, the heat-activated element 46 is activated by means of melting, burning, or softening at the activation temperature.

The heat-activated element 46 includes a force generator (e.g., spring 44), which is prevented from positioning the bar 42 by the heat-activated element 46 while in the unlocked position. The force generator provides means for the rod 36 to press onto the sealing lip 28 when the flexible protection element 16 is deployed to the protection arrangement. By way of example and not limitation, the locking device 40 comprises a wedge-shaped section to press against the rod 36 and act simultaneously as a pre-loading device. Another non-limiting example is that the force generator is a spring 44 (as illustrated in FIGS. 5A and 5B), which presses on the rod 36 in the event of a fire.

By way of example and not limitation, the heat-activated element 46 may include a spring 44 or another elastically preloaded element and a retention element. In such an example, the retention element prevents the spring 44 from exerting a force on the bar 42. The retention element is made of heat-activated material that releases the spring 44 when the activation temperature is exceeded. As a non-limiting example, the spring 44 is blocked by a non-heat resistant element, such as a plastic element or a metal element made of a metal with a low melting point. Preferably, the plastic element and/or the metal element may be made of a material with a melting point less than 450° C. In the event of a fire, the retention element may fail and lose its mechanical strength; for example, the plastic material softens or burns, or the metal material melts, and thus allowing the spring 44 to move freely and swing the bar 42 out. When the activation temperature is exceeded, the spring 44 presses the bar 42 into the activated position or locked state. The heat-activated element 46 may be made of an intumescent material that, as discussed above, expands in the event of a fire and exerts, directly or indirectly, a force on the bar 42, ensuring that the locking device 40 always securely locks in the event of a fire.

In contrast to FIG. 5A, FIG. 5B illustrates a schematic of the locking device 40 and bar 42 in an activated position or a locked position. FIG. 5B shows the state in which the retention element of the heat-activated element 46 is melted. As a result of heat-activated element 46 failing, the spring 44 positions the bar 42 to swing out. When the bar 42 swung out into position, the bar 42 swivels around a rotation point Z (as referenced in FIG. 5A). However, a person of ordinary skill in the art would appreciate that the bar 42 may be positioned into the activated position by a translational movement or along a track.

Further, a person of ordinary skill in the art would understand that the heat-activated element 46 may be advantageous but is not a mandatory component of the device 10. For example as an alternative, the heat-activated element 46 may not be present at all such that the bar 42 protrudes outwards at all times, and thus rod 36 is locked in the activated position. In the alternative, movement of the rod 36 in an upwards direction requires the bar 42 to be swung or swiveled in an inwards direction against the force of the spring 44. Such movement of bar 42 for the alternative may be accomplished manually by a user. However, preferably, an actuator may be provided to pull the bar 42 into the unlocked position.

Examples of an actuator include, but are not limited to, a pneumatically activated bellow or a McKibben muscle, which is activated by application of compressed air. Another non-limiting example may be a chemical actuator, in which a chemical reaction is caused by an electric signal and a gas is released. The released gas can activate a component, which becomes longer or shorter under pressure (similar to a bellow, cylinder or McKibben muscle) and which is connected to the bar 42. The chemical actuator may also be a detonator that, when ignited, releases gas rapidly. Another non-limiting example for an actuator is a solenoid. Further, a person of ordinary skill in the art would understand the present invention may use an electrically heated building component made of memory metal as an actuator.

Alternatively, the locking device 40 can be automatically activated, for example and not limitation, with an electro-magnet, an electric motor or another activation device. The smoke or fire protection device 10 may include an electrical control system for purposes of determining whether an electronic signal for deploying the flexible protection element 16 is a test signal or an emergency signal. If the electronic signal is a test signal, then the locking device 40 is not activated. However, if the electronic signal is an emergency signal, then the locking device 40 is activated.

For example, a motor 48 may be provided, which folds or puts the bar 42, by means of a tension rod, in the unlocked position such that the rod 36 can move past it. A sufficiently stronger electro-magnet may also be provided instead of the motor 48. Because the type of power is not relevant for the motor 48, the use of a pneumatic cylinder may be possible. Further, the locking device 40 may be positioned into the inactive state by the individual motor 48. Given this exemplary embodiment, the locking device 40 may constantly be activated in a locked position and may be formed by a snap-on mechanism.

### Protection Element

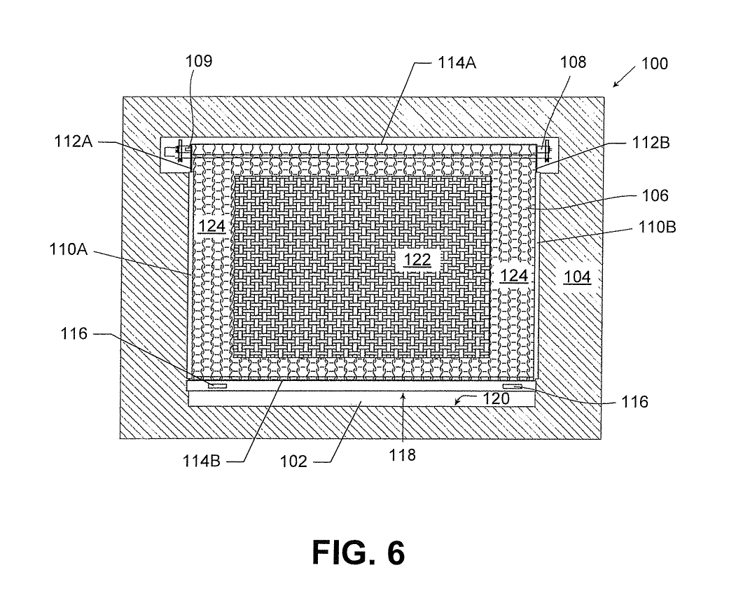

FIG. 6 displays a schematic, front elevational view of a smoke or fire protection device 100, in accordance with an example embodiment, for substantially sealing an opening 102 in a building structure and limiting the spread of fire and smoke through the opening 102 during a fire. The smoke or fire protection device 100 is adapted for secure connection to a wall 104 relative to the opening 102 and is configurable in the first configuration that permits ingress and egress through the opening 102 when no fire or smoke exists. The device 100 is also configurable in the second configuration in which the device 100 significantly limits or prevents the spread of fire and smoke through the opening 102 during a fire.

Similar to the exemplary embodiment illustrated in FIG. 1, the smoke or fire protection device 100 comprises a flexible protection element 106 and a winding shaft 108 about and onto which the flexible protection element 106 is fully-wound (and, hence, fully-retracted) when the device 100 is configured in the storage arrangement so as not to occlude the opening 102. Conversely, the flexible element 106 is fully-unwound from the winding shaft 108 when the device 100 is configured in the fully-deployed configuration so that the flexible protection element 106 fully occludes the opening 102. Thus, the flexible protection element 106 is selectively configurable to occlude or not occlude the opening 102. While the flexible protection element 106 may have multiple layers and multiple types of materials that are configured and manufactured in different arrangements in the various example embodiments described herein, the flexible protection element 106 generally includes a sheet-like member that is relatively thin in thickness as compared the lateral and longitudinal dimensions thereof.

In further similarity to the discussions above, the device 100 also comprises a winding shaft motor 109 mounted within the winding shaft 108 that is operable to rotate the winding shaft 108 in order to retract and wind the flexible protection element 106 onto the winding shaft 108 or to extend and unwind the flexible protection element 106 from the winding shaft 108. A first lead track 110A and an opposed second lead track 110B of the device 100 are secured to the wall 104 at respectively opposed locations relative to the opening 102 and define recesses therein for at least partially and respectively receiving opposed first and second lateral edges 112A, 112B of the flexible protection element 106. During winding or unwinding of the flexible protection element 106 onto/from the winding shaft 108 as the device 100 is reconfigured between the storage arrangement and fully-deployed configuration, the first and second lateral edges 112A, 112B of the flexible protection element 106 ride and move respectively within and relative to the recesses of the first and second lead tracks 110A, 110B. The tracks 110, according to the first example embodiment, may comprise channel, angle, plate, and/or other similar members appropriately sized and mounted relative to the wall 104 and opening 102 for receiving the lateral edges 112 of the flexible protection element 106. The tracks 110 are generally manufactured from an appropriately selected material capable of withstanding the high temperatures produced by fires absent yielding, deflection, or deformation.

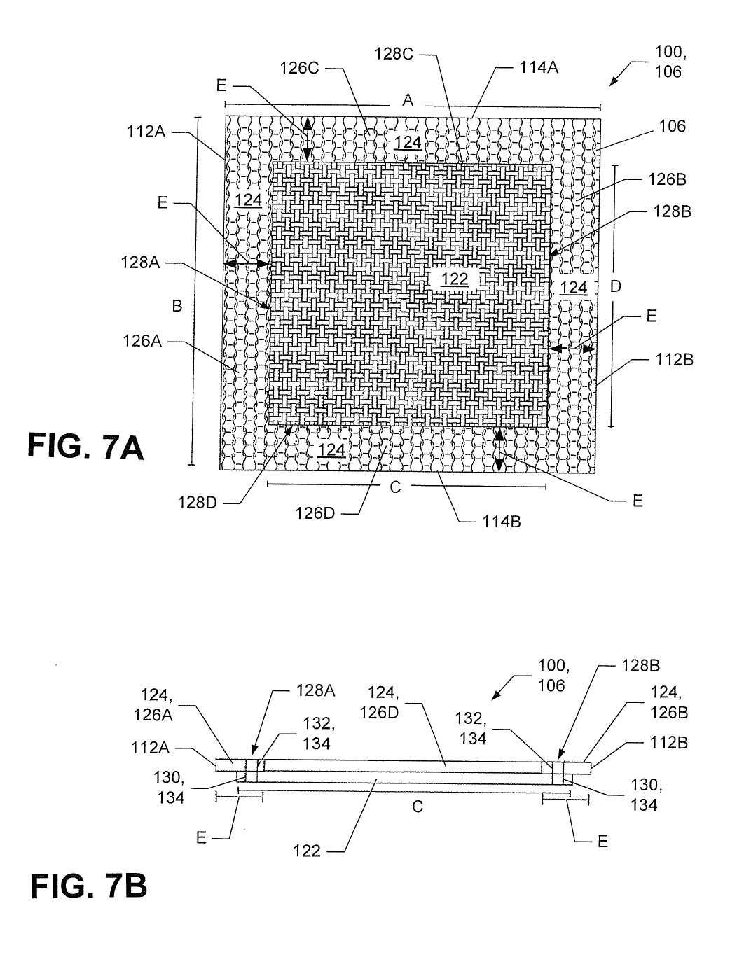

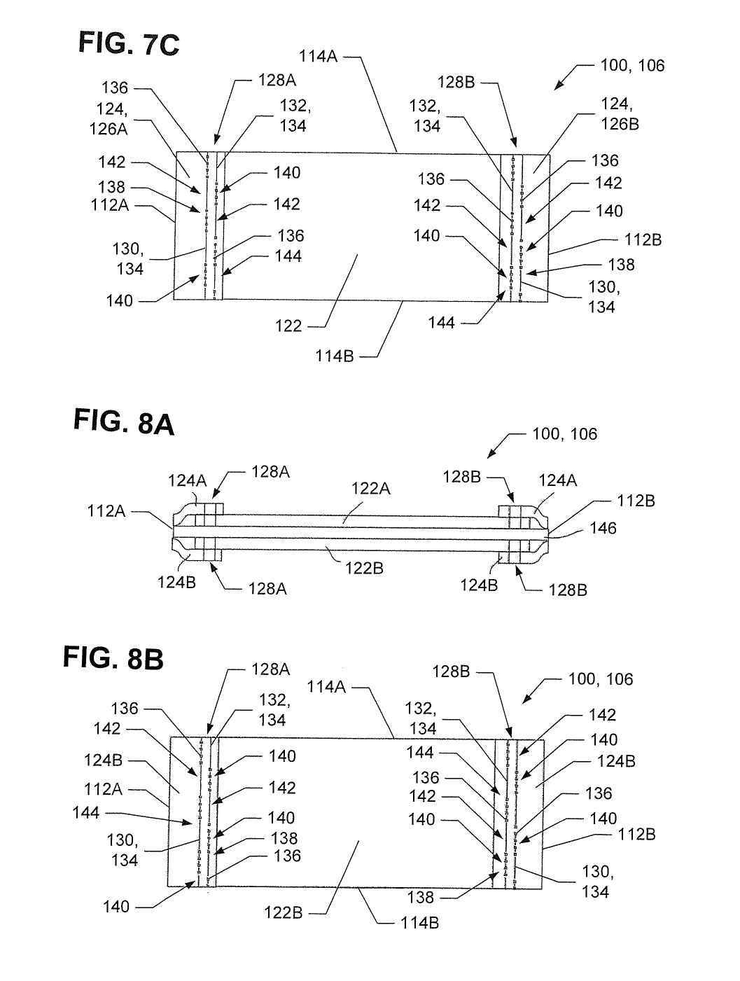

Additionally, the flexible protection element 106 has a first longitudinal edge 114A (see FIG. 7) and an opposed second longitudinal edge 114B that extend between the element's first and second lateral edges 112A, 112B. The first longitudinal edge 114A is generally secured to the winding shaft 108 to facilitate winding and unwinding of the flexible protection element 106 to or from the winding shaft 108. The smoke or fire protection device 100 further comprises a sealing lip 116 that is mounted to a foot 118 of the flexible protection element 106. The foot 118 is connected to and extends along the second longitudinal edge 114B of the flexible protection element 106 and at least between the lateral edges 112 thereof. When the device 100 is configured in the storage arrangement, the sealing lip 116 resides in a position flush with a first longitudinal edge of the opening 102 to permit ingress and egress through the opening 102. When the device 100 is configured in the protection arrangement, the sealing lip 116 resides in position in contact with and substantially parallel to a longitudinal edge 120 of the opening 102.

The flexible protection element 106 comprises a woven fabric element 122 manufactured from a woven fabric made from a non-flammable, fire resistant material having appropriate or desired fire resistance. The woven fabric has high structural stability and provides stability to the flexible protection element 106. A fire resistant material, acceptable according to the example embodiments described herein, may be obtained from KTex of Herzogenrath, Germany. The flexible protection element 106 further comprises a knitted fabric element 124 that laterally and longitudinally surrounds the woven fabric element 122 as the flexible protection element 106 is seen in FIG. 6. In accordance with the first example embodiment and other example embodiments described herein, the knitted fabric element 124 is manufactured from a non-flammable, fire resistant knitted fabric having at least one thread type comprising glass threads and at least one stainless steel wire (and/or a wire made from stainless steel). The knitted fabric has a course density in the range of one (1) to ten (10) courses per centimeter and/or a density in the range of one (1) to ten (10) weft threads or warp thread per centimeter.

Generally, the woven fabric element 122 and knitted fabric element 124 are each light in weight and contribute to the flexible protection element 106 also being relatively light in weight. Since knitted fabric has a relatively low resistance to deformation (especially when compared to woven fabric), the knitted fabric element 124 yields in response to external forces being applied to the flexible protection element 106. Thus, advantageously, the flexible protection elements 106 of the first and other example embodiments herein including knitted fabric element(s) 124 also have improved tolerance to external forces that may be applied to the flexible protection elements 106 during a fire such as, for example, the force exerted by a jet or stream of water from a fire hose. Additionally, when a flexible protection element 106 includes a woven fabric element 122 and a knitted fabric element 124, the flexible protection element 106 may be manufactured using known manufacturing processes. For example, known knitting machines may be used in the manufacture of the flexible protection element 106 including, for example and not limitation, circular or flat knitting machines. Acceptable knitting machines for the manufacture of the flexible protection element 106 according to the first and other example embodiments include known knitting machines made by the H. Stoll GmbH & Co. KG of Reutlingen, Germany and Mayer & Cie. GmbH & Co. KG of Tailfingen, Germany.

The term “knitted fabric” is used herein to refer a flat, material object made from a plurality of threads or thread systems that are connected with themselves or each other by stitches. A single type of thread or different types of threads may be used in the object. And, the object may be warp-knitted (warp knit) or weft-knitted (weft knit) with the weft-knitted object being more favored due to its ease of manufacture. If the object is woven, the object may comprise a weft-knitted fabric having only one thread that is simultaneously stitched by multiple needles. However, the object may also comprise a fabric made from several threads that are intertwined with each other.

FIGS. 7A, 7B and 7C respectively display schematic, front elevational, bottom plan, and partial back elevational views of the device's flexible protection element 106 in accordance with the first example embodiment. As illustrated in FIG. 7A and as described above with reference to FIG. 6, the flexible protection element 106 comprises a woven fabric element 122 and a knitted fabric element 124, and has a generally rectangular shape with an overall width (A) and an overall height (B). The woven fabric element 122 also has a generally rectangular shape with a width (C) (see FIG. 7B) and height (D) that are respectively smaller than the overall width (A) and overall height (B) of the flexible protection element 106 such that the knitted fabric element 124 appears to “frame” the woven fabric element 122 when viewed in FIG. 7A. In actuality, the knitted fabric element 124 comprises four portions 126A, 126B, 126C and 126D, each having a substantially rectangular shape as seen in FIGS. 7A and 7B and each having a dimension (E) that is less than the width and height of the woven fabric element 122. Each knitted fabric element portion 126A, 126B, 126C, 126D is arranged relative to the woven fabric element 122 so that it overlaps part of the woven fabric element 122 as illustrated in FIG. 7B. It should be understood and appreciated that while each portion 126A, 126B, 126C and 126D of the knitted fabric element 124 has an equal dimension (E) according to the first example embodiment, each portion 126A, 126B, 126C and 124D of the knitted fabric element 124 may have a dimension (E) in other example embodiments that is the same as or different from one or more of the other portions 126A, 126B, 126C and 126D of the knitted fabric element 124.

Each portion 126A, 126B, 126C and 126D of the knitted fabric element 124 is generally secured to the woven fabric element 122 in a similar manner via a seam 128 formed there between in the respective regions where each portion 126A, 126B, 126C and 126D of the knitted fabric element 124 respectively overlaps the woven fabric element 122. Seams 128A and 128B are illustrated in FIGS. 7B and 7C, and secure portions 126A and 126B of the knitted fabric element 124 to the woven fabric element 122. Seams 128C and 128D similarly secure portions 126C and 126D of the knitted fabric element 124 to the woven fabric element 122, but are not visible in FIGS. 7B and 7C and, hence, are not described herein.

According to the first example embodiment, each seam 128 is formed at least in part by a first row of stitches 130 and a second row of stitches 132 using thread 134 to couple a respective portion 126A, 126B, 126C and 126D of the knitted fabric element 124 to the woven fabric element 122 (see FIGS. 7B and 7C). The first row of stitches 130 of each seam 128 is substantially parallel to the second row of stitches 132 of the same seam 128. Each row of stitches 130, 132 includes a plurality of individual stitches 136 (illustrated as squares in FIG. 7C) arranged in a stitching pattern 138 in which the stitches 136 are positioned relatively close together in groups of stitches 140 separated or offset from preceding and succeeding groups of stitches 140 by gaps 142 and thread 134 extending across the gaps 142. Additionally, the first and second rows of stitches 130, 132 are arranged in a stitching arrangement 144 in which the first row of stitches 130 is offset relative to the second row of stitches 132 such that groups of stitches 140 of the first row of stitches 130 reside substantially adjacent to gaps 142 in the second row of stitches 132 and groups of stitches 140 of the second row of stitches 132 reside substantially adjacent to gaps 142 in the first row of stitches 130. By configuring the rows of stitches 130, 132 according to stitching arrangement 144, each seam 128 is able to expand so that an unequal stretch between the knitted fabric element 124 and woven fabric element 122 does not lead to an excessively great strain on the fire resistant material in the area around the stitches 136. In other example embodiments and to provide additional coupling strength, the knitted fabric element 124 and the woven fabric element 122 may be held together not only by seams 128, but also by an adhesive film arranged between the knitted fabric element 124 and the woven fabric element 122.

The thread 134 used to couple the knitted fabric element 124 to the woven fabric element 122 comprises, in accordance with the first example embodiment, a fire resistant thread 134, thereby making each seam 128 more fire resistant and increasing the likelihood of the knitted fabric element 124 remaining coupled to the woven fabric element 122 when exposed to fire. The fire resistant thread 134 generally includes multiple metal threads or at least one metal wire including, for example and not limitation, a wire made from steel or, more preferably, from stainless steel. By using such wires, the thread 134 has high resistance to fire, but yet is sufficiently flexible to enable the flexible protection element 106 to be wound around and unwound from winding shaft 108. As an alternative, the thread 134 may comprise cotton, glass, or aramid fibers, and/or a combination thereof.

FIGS. 8A and 8B respectively display bottom plan and partial back elevational schematic views of a flexible protection element 106 in accordance with an example embodiment. The flexible protection element 106 of the depicted embodiment comprises a first woven fabric element 122A coupled to a first knitted fabric element 124A via seams 128A formed in substantially the same manner as in the example embodiment shown in FIG. 6. However, the flexible protection element 106 also comprises a second woven fabric element 122B coupled to a second knitted fabric element 124B via seams 128B also formed in substantially the same manner as in the example embodiment illustrated in FIG. 6. Additionally, the flexible protection element 106 comprises an intumescent material member 146 positioned between the first and second woven fabric elements 122A, 122B. Together, the first and second woven fabric elements 122A, 122B, the first and second knitted fabric elements 124A, 124B, and the intumescent material member 146 form a sandwich structure or arrangement.

As discussed above and used herein, the term “intumescent” refers to a material having a heat consuming, or endothermic, physical reaction or an endothermal chemical reaction when exposed to heat. A detailed discussion on an intumescent material acceptable for use in the intumescent material member 146 in accordance with the example embodiments herein is provided above.

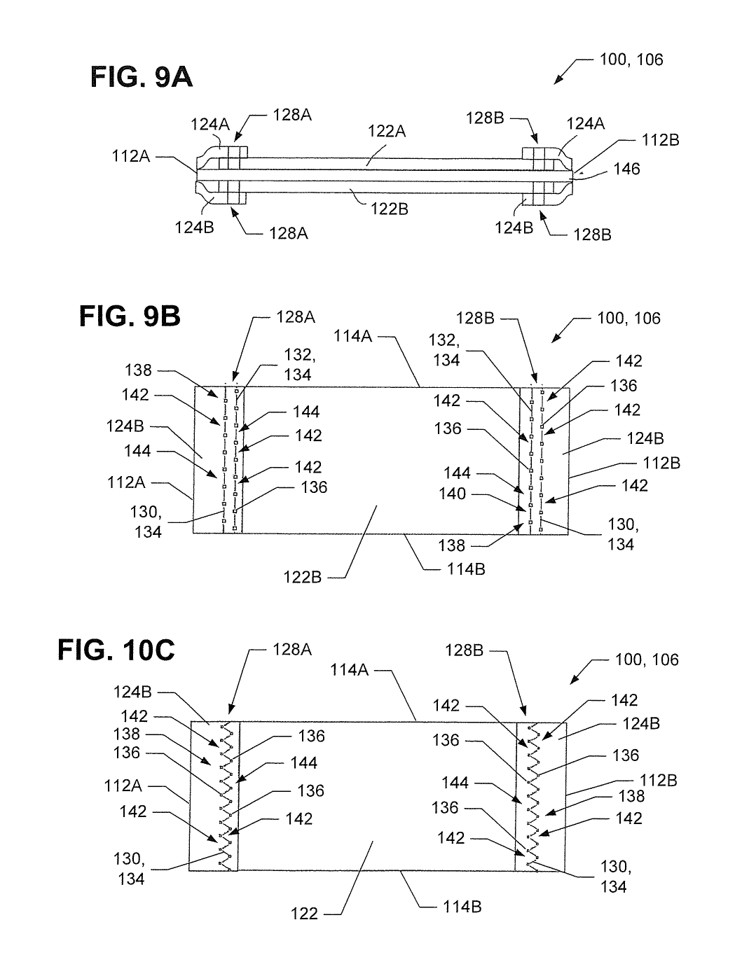

FIGS. 9A and 9B respectively display bottom plan and partial back elevational schematic views of a flexible protection element 106 in accordance with an example embodiment. The flexible protection element 106 of this example embodiment is substantially similar to the flexible protection element 106 described above with respect to FIGS. 8A and 8B. However, in the flexible protection element 106 of this example embodiment, the first woven fabric element 122A is coupled to a first knitted fabric element 124A via seams 128A and the second woven fabric element 122B is coupled to a second knitted fabric element 124B via seams 128B, where seams 128A, 128B are formed in different manner than the seams 128 of the previous example embodiments. More particularly, each row of stitches 130, 132 includes a plurality of individual stitches 136 (illustrated as squares in FIG. 7C) arranged in a stitching pattern 138 in which the stitches 136 are not positioned together in groups of stitches 140 as in the previous example embodiments. Instead, the stitches 136 of each row of stitches 130, 132 are arranged in a stitching pattern 138 in which each stitch 136 is separated, or offset, from preceding and succeeding stitches 136 by a gap 142 and thread 134 extending across each gap 142. In addition, the first and second rows of stitches 130, 132 are arranged in a stitching arrangement 144 in which the first row of stitches 130 is offset relative to the second row of stitches 132 such that stitches 136 of the first row of stitches 130 reside substantially adjacent to gaps 142 in the second row of stitches 132 and stitches 136 of the second row of stitches 132 reside substantially adjacent to gaps 142 in the first row of stitches 130. Advantageously, the use of stitching pattern 138 and stitching arrangement 144 to form seams 128 is not damaging to the fire resistant material of the woven fabric element 122 and knitted fabric element 124. Further, the use of stitching pattern 138 and stitching arrangement 144 also renders the seams 128 more flexible when stretched along their length than if other stitching patterns or stitching arrangements were used. Due to such increased flexibility, the seams 128 tend to minimize the force transmitted to the fire resistant fabrics when a force is exerted on the flexible protection element 106.

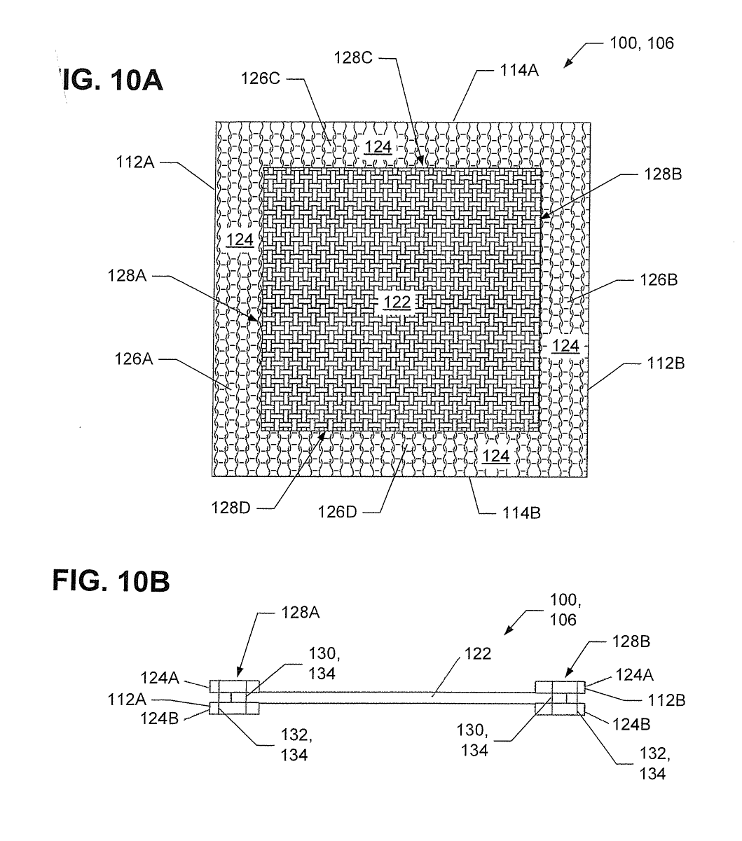

FIGS. 10A, 10B and 10C respectively display front elevational, bottom plan, and partial back elevational schematic views of the device's flexible protection element 106 in accordance with an example embodiment. The flexible protection element 106 of this example embodiment is substantially similar to the flexible protection element 106 of the example embodiment described above in regards to FIG. 6 with the exception that the woven fabric element 122 is coupled near its lateral edges to a first knitted fabric element 124A and a second knitted fabric element 124B via seams 128. Also, the seams 128 axe formed in a different manner than the seams 128 of the prior example embodiment. More specifically, each seam 128 is formed by a first row of stitches 130 including a plurality of individual stitches 136 (illustrated as squares in FIG. 10C) arranged in a stitching pattern 138 comprising a zigzag pattern in which each stitch 136 is laterally and longitudinally separated, or offset, from preceding and succeeding stitches 136 by a gap 142 and thread 134 extending across each gap 142. Each seam 128 may also be formed by a second row of stitches 132 arranged in a stitching pattern (not shown in FIG. 10C) comprising a zigzag pattern similar to the first row of stitches 130 or a stitching pattern similar to those stitching patterns of the example embodiments shown in FIGS. 6, 9A and 9B. Advantageously, stitches 136 arranged in a zigzag pattern 138 produce a relatively flexible seam 128. Because the knitted fabric elements 124A, 124B stretch easily, the presence of flexible seams 128 tends to prevent the woven fabric element 122 from becoming uncoupled and separated from the knitted fabric elements 124A, 124B.

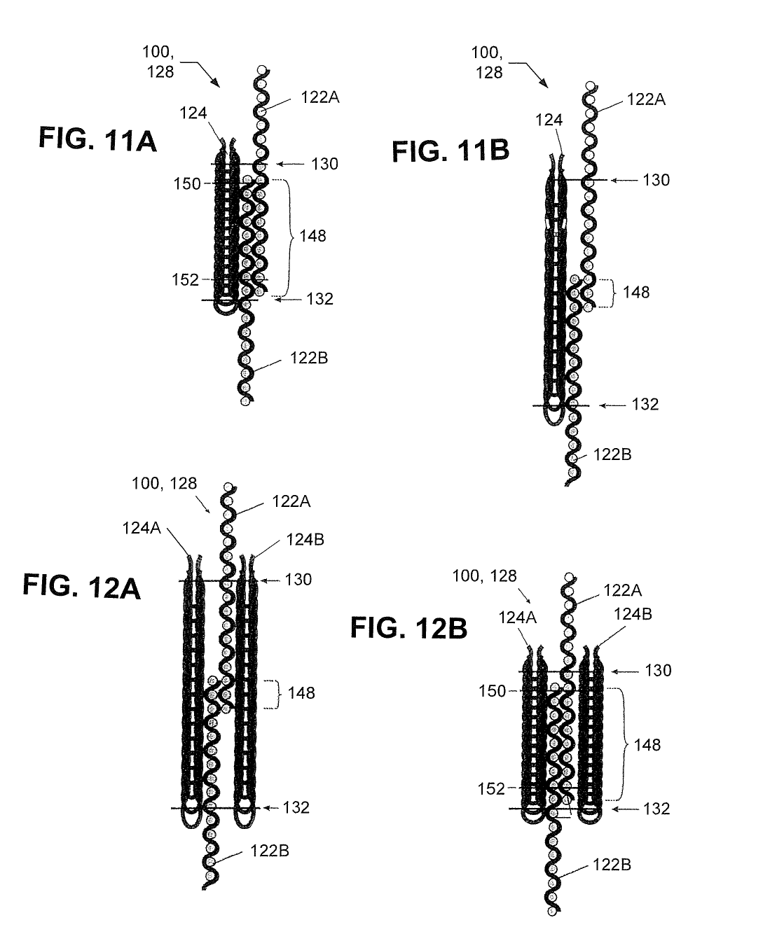

The flexible protection elements 106 of the second, third and fourth example embodiments described above in FIGS. 8A, 8B, 9A, 9B, 10A, 10B and 10C highlight the benefits obtained through the use of seams 128 having particular stitching patterns 138 and stitching arrangements 144 in minimizing the adverse effects of forces applied to the flexible protection elements 106. Similarly, the flexible protection elements 106 of the example embodiments described below with respect to FIGS. 11A, 11B, 12A and 12B highlight similar benefits obtained through the use of seams 128 formed between woven fabric elements 122 and knitted fabric elements 124 with fire resistant 134 and non-fire resistant thread 154.

FIG. 11A displays a schematic, cross-sectional view of a seam 128 of a multi-layer flexible protection element 106 having a single knitted fabric element 124, in accordance with an example embodiment, prior to exposure to fire. As seen in FIG. 11A, the flexible protection element 106 comprises a first woven fabric element 122A, a second woven fabric element 122B, and a knitted fabric element 124 that are substantially similar to those of the embodiments depicted in FIGS. 8A, 8B, 9A and 9B. In this example embodiment, the first woven fabric element 122A, second woven fabric element 122B, and knitted fabric element 124 form a multi-layer structure. As seen in FIG. 11A, a portion of the second woven fabric element 122B is positioned immediately adjacent to and between a portion of the first woven fabric element 122A and the knitted fabric element 124. The first woven fabric element 122A overlaps the second woven fabric element 122B to form two or more layers in an overlap zone 148. Outside of the overlap zone 148, the woven fabric elements 122A, 122B form only a single layer.

The seam 128 is formed between the woven fabric elements 122A, 122B and the knitted fabric element 124 by a first row of stitches 130 between woven fabric element 122A and the knitted fabric element 124 and by a second row of stitches 132 between woven fabric element 122B and the knitted fabric element 124. The first and second rows of stitches 130, 132 are made using fire resistant thread 134. The seam 128 is also formed between the woven fabric elements 122A, 122B and the knitted fabric element 124 third and fourth rows of stitches 150, 152 that extend between and through woven fabric elements 122A, 122B and the knitted fabric element 124. The third and fourth rows of stitches 150, 152 are made using non-fire resistant thread 154.

During exposure of the multi-layer structure and seam 128 to fire, the third and fourth rows of stitches 150, 152 are undone or destroyed, and the knitted fabric element 124 expands and stretches. With the third and fourth tows of stitches 150, 152 undone or destroyed as seen in FIG. 11B after exposure to fire, the woven fabric elements 122A, 122B are connected to the knitted fabric element 124 only by the first and second rows of stitches 130, 132 and the overlap zone 148 has substantially come undone with minimal overlap remaining and a sizable gap 156 being created between the first woven fabric element 122A and the knitted fabric element 124. However, by virtue of the third and fourth rows of stitches 150, 152 coming undone without the first and second rows of stitches 130, 132 coming undone, the knitted fabric element 124 is permitted to stretch and absorb the forces acting on the flexible protection element 106 during a fire. As a consequence, any distortion is focused in the knitted fabric element 124 and not in the woven fabric elements 122A, 122B. By together enabling the absorption of the forces, the undoing of the third and fourth rows of stitches 150, 152 and the elasticity of the knitted fabric element 124 aid the flexible protection element 106 in avoiding the adverse effects of an external force.

FIG. 12A displays a schematic, cross-sectional view of a seam 128 of a multi-layer flexible protection element 106, in accordance with an example embodiment, prior to exposure to fire. The flexible protection element 106 comprises a first woven fabric element 122A, a second woven fabric element 122B, a first knitted fabric element 124A, and a second knitted fabric element 124B that are substantially similar to those of the example embodiments provided by FIGS. 8A, 8B, 9A and 9B. In the present example embodiment, the first and second woven fabric elements 122A, 122B, and first and second knitted fabric elements 124B form a multi-layer structure. As seen in FIG. 12A, the first and second woven fabric elements 122A, 122B are positioned immediately adjacent one another such that a portion of the first woven fabric element 122A overlaps a portion of the second woven fabric element 122B to define an overlap zone 148. The first knitted fabric element is located immediately adjacent a portion of the first woven fabric element 122A and the second knitted fabric element is located immediately adjacent a portion of the second woven fabric element 122A.

The seam 128 is formed between the woven fabric elements 122A, 122B and the knitted fabric elements 124A, 124B by a first row of stitches 130 extending between knitted fabric element 124A, woven fabric element 122A, and knitted fabric element 124B and by a second row of stitches 132 extending between knitted fabric element 124A, woven fabric element 122B, and knitted fabric element 124B. The first and second rows of stitches 130, 132 are made using fire resistant thread 134. The seam 128 is also formed between the woven fabric elements 122A, 122B and the knitted fabric elements 124A, 124B by third and fourth rows of stitches 150, 152 that extend between and through woven fabric elements 122A, 122B and knitted fabric elements 124A, 124B. The third and fourth rows of stitches 150, 152 are made using non-fire resistant thread 154.

Similar to seam 128 of the example embodiment illustrated by FIGS. 11A and 11B, the third and fourth rows of stitches 150, 152 of seam 128 of the present example embodiment are undone or destroyed during exposure of the multi-layer structure and seam 128 to fire. As seen in FIG. 12B and with the third and fourth rows of stitches 150, 152 undone or destroyed, the knitted fabric elements 124A, 124B expand and stretch, and the overlap zone 148 is substantially reduced in size. Also, the first woven fabric element 122A remains connected to knitted fabric elements 124A, 124B only by the first row of stitches 130, and the second woven fabric element 122B remains connected to knitted fabric elements 124A, 124B only by the second row of stitches 132. Advantageously, while the overlap zone 148 has been significantly reduced in size due to the effects of fire, the overlap zone 148 remains covered on both sides by the knitted fabric elements 124A, 124B and the knitted fabric elements 124A, 124B have been permitted to absorb harmful forces acting on the flexible protection element 106.

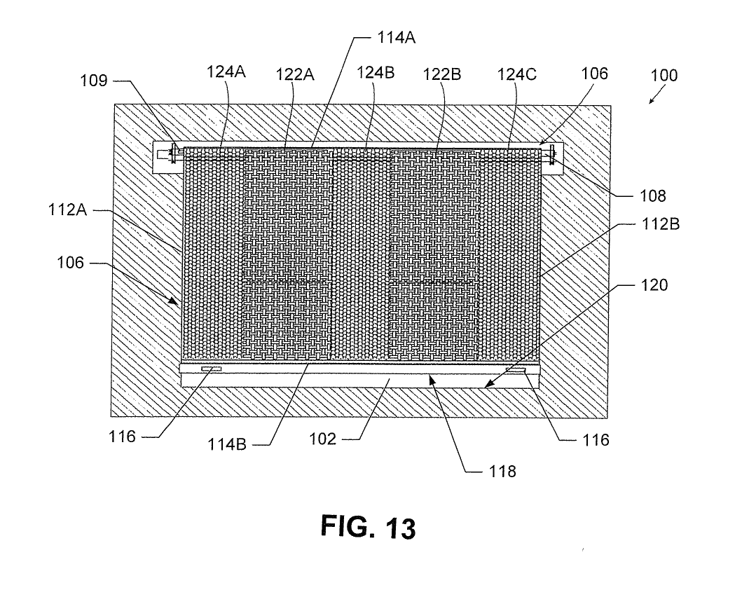

FIG. 13 displays a smoke or fire protection device 100, in accordance with an example embodiment, for substantially sealing an opening 102 in a building structure and limiting the spread of fire and smoke through the opening 102 during a fire. The device 100 is substantially similar to the device 100 of the example embodiment of FIG. 6, except that the flexible protection element 106 is configured differently. According to this example embodiment and as seen in the intermediate configuration of FIG. 13, the flexible protection element 106 has a first lateral edge 112A and an opposed second lateral edge 112B. Additionally, the flexible protection element 106 has a first longitudinal edge 114A and an opposed second longitudinal edge 114B that extend between the element's first and second lateral edges 112A, 112B. The first longitudinal edge 114A is generally secured to the winding shaft 108 to facilitate winding and unwinding of the flexible protection element 106 to or from the winding shaft 108. The second longitudinal edge 114B is connected to a foot 118 of the flexible protection element 106 that contacts an edge of the opening 102 when the device 100 is configured in the fully-deployed configuration.

As seen in FIG. 13, the flexible protection element 106 comprises multiple elongate woven fabric elements 122 and multiple elongate knitted fabric elements 124 that each extend between the longitudinal edges 114A, 114B of the flexible protection element 106. However, each of the multiple elongate woven fabric elements 122 and multiple elongate knitted fabric elements 124 extend only partially between the lateral edges 112A, 112B of the flexible protection element 106 such that the multiple elongate woven fabric elements 122 and multiple elongate knitted fabric elements 124 are arranged adjacent to one another in the form of fabric strips. In such arrangement, the elongate woven fabric elements 122 and elongate knitted fabric elements 124 are configured alternately in the lateral direction between the lateral edges 112A, 112B of the flexible protection element 106. Thus, a first elongate knitted fabric element 124A is positioned at and aligned along the first lateral edge 112A of the flexible protection element 106. A first elongate woven fabric element 122A extends adjacent to the first elongate knitted fabric element 124A nearest lateral edge 112B and is coupled to the first elongate knitted fabric element 124A by a first seam 128A. A second elongate knitted fabric element 124B extends adjacent to the first elongate woven fabric element 122A nearest lateral edge 112B and is coupled to the first elongate woven fabric element 122A by a second seam 128B. A second elongate woven fabric element 122B extends adjacent to the second elongate knitted fabric element 124B nearest lateral edge 112B and is coupled to the first elongate knitted fabric element 124B by a third seam 128C. A third elongate knitted fabric element 124C extends adjacent to the second elongate woven fabric element 122B positioned at and aligned with the second lateral edge 112B of the flexible protection element 106 and is coupled to the second elongate woven fabric element 122B by a fourth seam 128D.

Seams 128A, 128B, 128C and 128D are formed substantially similar to seams 128 of the example embodiment described above in FIG. 6 using fire resistant thread. It should be understood and appreciated, however, that seams 128A, 128B, 128C and 128D may alternatively use one or more rows of stitches, one or more stitching patterns, and one or more stitching arrangements as described or not described in the other example embodiments. It should also be understood and appreciated that the woven fabric elements 122 and knitted fabric elements 124 may be present in different numbers, different sizes and be arranged in different arrangements in other example embodiments.

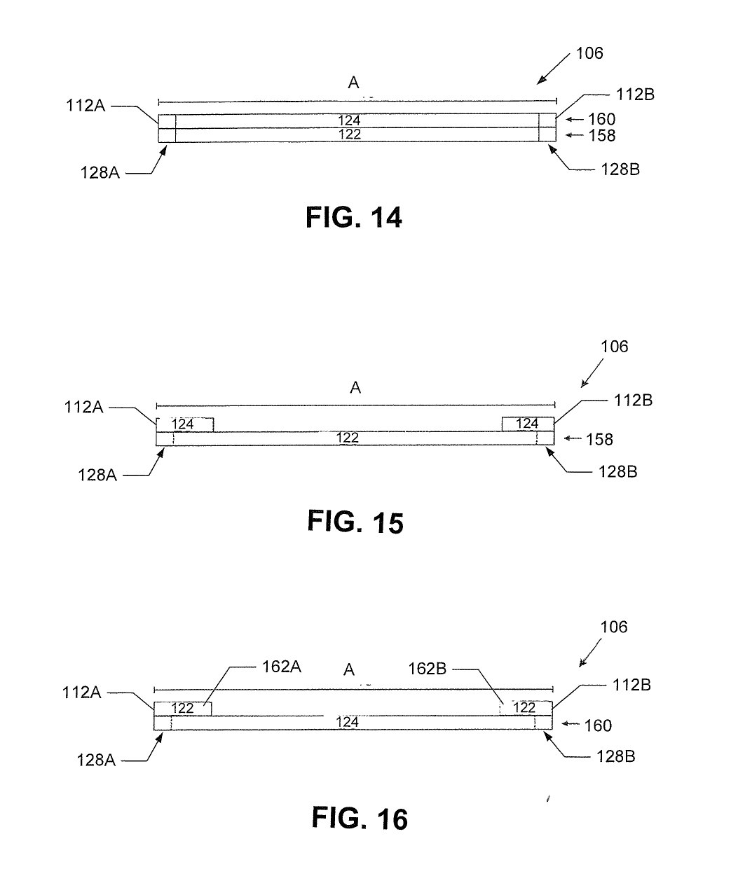

FIG. 14 displays a schematic, top plan view of a flexible protection element 106 in accordance with an example embodiment. As illustrated in FIG. 14, the flexible protection element 106 has a first lateral edge 112A, an opposed second lateral edge 112B, and a general shape substantially similar to the flexible protection elements 106 of this other example embodiments described herein. The flexible protection element 106 of this example embodiment comprises a woven fabric layer 158 and a knitted fabric layer 160. The woven fabric layer 158 includes a woven fabric element 122 that extends entirely between the first and second lateral edges 112A, 112B of the flexible protection element 106. The knitted fabric layer 160 includes a knitted fabric element 124 that also extends entirely between the first and second lateral edges 112A, 112B of the flexible protection element 106. Thus, the woven fabric element 122 and knitted fabric element 124 extend entirely adjacent and substantially parallel to one another. The woven fabric element 122 and knitted fabric element 124 are coupled together by seams 128A, 128B that are formed substantially similar to the seams 128 of the first example embodiment described above using fire resistant thread 134. It should be understood and appreciated, however, that seams 128A, 128B may alternatively use one or more rows of stitches, one or more stitching patterns, and one or more stitching arrangements as described or not described in the other example embodiments. It should also be understood and appreciated that in other example embodiments, the flexible protection element 106 may comprise additional woven fabric elements, knitted fabric elements, and/or layers of woven fabric, knitted fabric, intumescent, or other materials in the same or different sizes, shapes and arrangements.

FIG. 15 displays a schematic, top plan view of a flexible protection element 106 in accordance with an example embodiment. As illustrated in FIG. 15, the flexible protection element 106 has a first lateral edge 112A, an opposed second lateral edge 112B, and a general shape substantially similar to the flexible protection elements 106 of the other example embodiments described herein. The flexible protection element 106 of the ninth example embodiment comprises a woven fabric layer 158. The woven fabric layer 158 includes a woven fabric element 122 that extends entirely between the first and second lateral edges 112A, 112B of the flexible protection element 106. The flexible protection element 106 also comprises a knitted fabric element 124 that, unlike the woven fabric element 122, does not extend entirely between the first and second lateral edges 112A, 112B of the flexible protection element 106. Instead, the knitted fabric element 124 includes a first portion 126A and an opposed second portion 126B, each having a substantially rectangular shape when seen in top plan view. The first portion 126A of the knitted fabric element 124 is positioned adjacent to and aligned with the first lateral edge 112A of the flexible protection element 106. The second portion 126B of the knitted fabric element 124 is positioned adjacent to and aligned with the second lateral edge 112B of the flexible protection element 106. Each of the first and second portions 126A, 126B extends adjacent to the woven fabric element 122 and is generally secured to the woven fabric element 122 via seams 128A, 128B formed with the woven fabric element 122. Seams 128 are formed substantially similar to seams 128 of the first example embodiment described above using fire resistant thread 134. It should be understood and appreciated, however, that seams 128A, 128B may alternatively use one or more rows of stitches, one or more stitching patterns, and one or more stitching arrangements as described or not described in the other example embodiments. It should also be understood and appreciated that in other example embodiments, the flexible protection element 106 may comprise additional woven fabric elements, knitted fabric elements, and/or layers of woven fabric, knitted fabric, intumescent, or other materials in the same or different sizes, shapes and arrangements.

FIG. 16 displays a schematic, top plan view of a flexible protection element 106 in accordance with an example embodiment. As illustrated in FIG. 16, the flexible protection element 106 has a first lateral edge 112A, an opposed second lateral edge 112B, and a general shape substantially similar to the flexible protection elements 106 of the other example embodiments described herein. The flexible protection element 106 of the present example embodiment comprises a knitted fabric layer 160. The knitted fabric layer 160 includes a knitted fabric element 124 that extends entirely between the first and second lateral edges 112A, 112B of the flexible protection element 106. The flexible protection element 106 also comprises a woven fabric element 122 that, unlike the knitted fabric element 124, does not extend entirely between the first and second lateral edges 112A, 112B of the flexible protection element 106. Instead, the woven fabric element 122 includes a first portion 162A and an opposed second portion 162B, each having a substantially rectangular shape when seen in top plan view. The first portion 162A of the woven fabric element 122 is positioned adjacent to and aligned with the first lateral edge 112A of the flexible protection element 106. The second portion 162B of the woven fabric element 122 is positioned adjacent to and aligned with the second lateral edge 112B of the flexible protection element 106.

Each of the first and second portions 162A, 162B of the woven fabric element 122 extends adjacent to the knitted fabric element 124 and is generally secured to the knitted fabric element 124 via seams 128A, 128B formed with the knitted fabric element 124. Seams 128 are formed substantially similar to seams 128 of the example embodiment described above in FIG. 6 using fire resistant thread 134. It should be understood and appreciated, however, that seams 128A, 128B may alternatively use one or more rows of stitches, one or more stitching patterns, and one or more stitching arrangements as described or not described in the other example embodiments. It should also be understood and appreciated that in other example embodiments, the flexible protection element 106 may comprise additional woven fabric elements, knitted fabric elements, and/or layers of woven fabric, knitted fabric, intumescent, or other materials in the same or different sizes, shapes and arrangements.

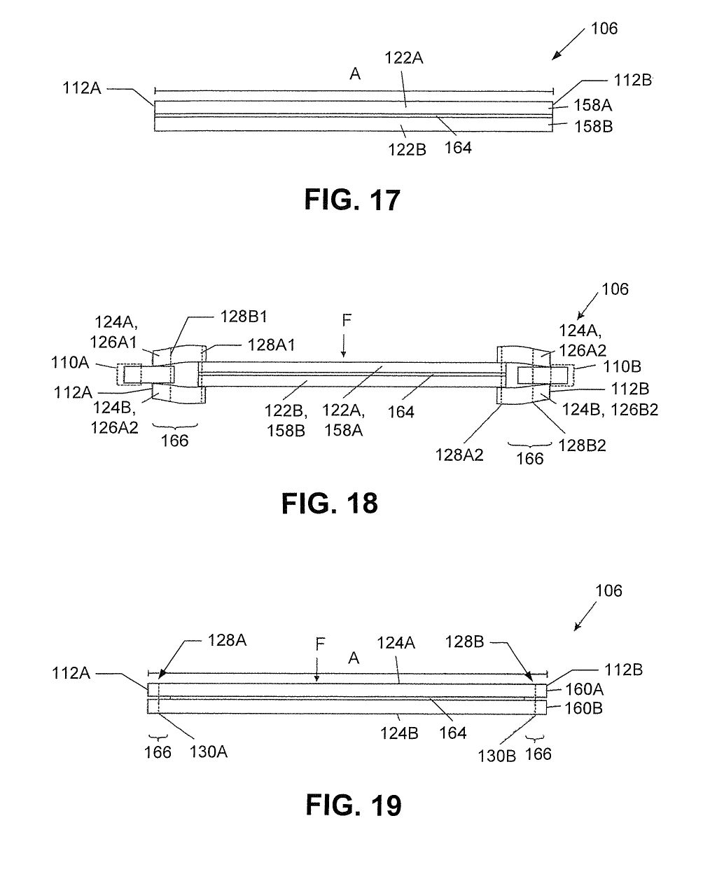

FIG. 17 displays a schematic, top plan view of a flexible protection element 106 in accordance with an example embodiment. As illustrated in FIG. 17, the flexible protection element 106 has a first lateral edge 112A, an opposed second lateral edge 112B, and a general shape substantially similar to the flexible protection elements 106 of the other example embodiments described herein. The flexible protection element 106 of this example embodiment comprises a first woven fabric layer 158A and a second woven fabric layer 158B. The first woven fabric layer 158A includes a woven fabric element 122A that extends entirely between the first and second lateral edges 112A, 112B of the flexible protection element 106. The second woven fabric layer 158B includes a woven fabric element 122B that also extends entirely between the first and second lateral edges 112A, 112B of the flexible protection element 106. Thus, the first woven fabric element 122A and the second woven fabric element 122B extend substantially parallel to one another.

The flexible protection element 106 further comprises a metal foil element 164 that extends between the first and second lateral edges 112A, 112B of the flexible protection element 106. The metal foil element 164 is positioned between the first and second woven fabric elements 122A, 122B and is adjacent and substantially parallel thereto forming a multi-layer, sandwich structure. As used herein, the term “metal foil” refers generally to a foil made from steel, titanium, or copper (since copper does not rust), but may include other metal materials or alloys in various example embodiments. However, according to this and other example embodiments described herein, the metal foil element 164 is manufactured from high grade, stainless steel such as, for example and not limitation, V4A steel (also known as 1.4404 steel) or a stainless steel having eighteen percent (18%) chrome and ten percent (10%) nickel that demonstrates low stain hardening, as the flexible protection element 106 may be rolled and unrolled many times to test operation of the smoke or fire protection device 100. Alternatively, the metal foil element 164 may be manufactured from a steel whose yield strength increases with heating (such as, for example, a dual phase steel) in order to provide the flexible protection element 106 with increased strength during and after a fire. Generally, the metal foil has a thickness between twenty micrometers (20 μm) and two hundred micrometers (200 μm) when the metal foil is not used alone in a flexible protection element 106. When the metal foil is used alone, the metal foil typically has a thickness of more than one hundred micrometers (100 μm).

The woven fabric elements 122A, 122B and the metal foil element 164 are coupled together by seams (not shown) that are formed substantially similar to the seams 128 of the example embodiment described above in FIG. 6 using fire resistant thread 134. It should be understood and appreciated, however, that seams 128A, 128B may alternatively use one or more rows of stitches, one or more stitching patterns, and one or more stitching arrangements as described or not described in the other example embodiments. It should also be understood and appreciated that in other example embodiments, the flexible protection element 106 may comprise additional woven fabric elements, knitted fabric elements, intumescent elements, metal foil elements, and/or layers of woven fabric, knitted fabric, intumescent, metal foil, or other materials in the same or different sizes, shapes and arrangements.

It should be understood and appreciated that the metal foil element 164 of this example embodiment (and, for that matter, the other example embodiments described herein) is self-supporting, meaning that it is sufficiently strong and stable enough to carry its own weight absent support from other elements or components. By virtue of the metal foil elements 164 being self-supporting, the flexible protection elements 106 described herein having metal foil elements 164 as a single or central element of a multi-layer structure are possible, but would not be possible if the metal foil elements 164 comprised metal foil merely mounted on a fire resistant material.

FIG. 18 displays a schematic, top plan view of a flexible protection element 106 in accordance with an example embodiment. As illustrated in FIG. 18, the flexible protection element 106 has a first lateral edge 112A, an opposed second lateral edge 112B, and a general shape substantially similar to the flexible protection elements 106 of the other example embodiments described herein. The flexible protection element 106 of this example embodiment comprises a first woven fabric layer 158A and a second woven fabric layer 158B. The first woven fabric layer 158A includes a woven fabric element 122A that extends partially between the first and second lateral edges 112A, 112B of the flexible protection element 106. The second woven fabric layer 158B includes a woven fabric element 122B that also extends partially between the first and second lateral edges 112A, 112B of the flexible protection element 106. Thus, the first woven fabric element 122A and the second woven fabric element 122B extend substantially parallel to one another.

The flexible protection element 106 further comprises a metal foil element 164 that extends partially between the first and second lateral edges 112A, 112B of the flexible protection element 106 to the same extent as the woven fabric elements 122. The metal foil element 164 is positioned between the first and second woven fabric elements 122A, 122B and is adjacent and substantially parallel thereto forming a multi-layer, sandwich structure. According to the present example embodiment, the metal foil element 164 is manufactured from high grade steel such as, for example and not limitation, V4A steel (also known as 1.4.40 steel). It should be understood and appreciated that the metal foil element 164 may be manufactured from other types of steels or metals in other example embodiments.

Additionally, the flexible protection element 106 comprises first and second knitted fabric elements 124A, 124B that are positioned partially adjacent to the first woven fabric element 122A and second woven fabric element 122B, respectively. The first knitted fabric element 124A includes first and second portions 126A1, 126A2 that each extend only partially between the first and second lateral edges 112A, 112B of the flexible protection element 106. The first portion 126A1 of the first knitted fabric element 124A overlaps a first end of the woven fabric elements 122A, 122B and metal foil element 164 and extends to the first lateral edge 112A of the flexible protection element 106. The second portion 126A2 of the first knitted fabric element 124A overlaps a second end of the woven fabric elements 122A, 122B and metal foil element 164 and extends to the second lateral edge 112B of the flexible protection element 106. Similarly, the second knitted fabric element 124B includes first and second portions 126B1, 126B2 that each extend only partially between the first and second lateral edges 112A, 112B of the flexible protection element 106. The first portion 126B1 of the second knitted fabric element 124B overlaps a first end of the woven fabric elements 122A, 122B and metal foil element 164 and extends to the first lateral edge 112A of the flexible protection element 106. The second portion 126B2 of the second knitted fabric element 124B overlaps a second end of the woven fabric elements 122A, 122B and metal foil element 164 and extends to the second lateral edge 112B of the flexible protection element 106. The first and second knitted fabric elements 124 are connected to leads near lateral edges 112A, 112B.

The woven fabric elements 122, knitted fabric elements 124, and metal foil element 164 are coupled together by a plurality of seams 128. More specifically, the first portion 126A1 of the first knitted fabric element 124A, woven fabric elements 122A, 122B, metal foil element 164, and the first portion 126B1 of the second knitted fabric element 124B are coupled together by seam 128A1. Similarly, the second portion 126A2 of the first knitted fabric element 124A, woven fabric elements 122A, 122B, metal foil element 164, and the second portion 126B2 of the second knitted fabric element 124B are coupled together by seam 128A2. The first portion 126A1 of the first knitted fabric element 124A and the first portion 126B1 of the second knitted fabric element 124B are coupled together by seam 128B1. Similarly, the second portion 126A2 of the first knitted fabric element 124A and the second portion 126B2 of the second knitted fabric element 124B are coupled together by seam 128B2. The seams 128 are formed in a manner that is substantially similar to the seams 128 of the example embodiment described above in FIG. 6 using fire resistant thread 134. It should be understood and appreciated, however, that seams 128 may alternatively use one or more rows of stitches, one or more stitching patterns, and one or more stitching arrangements as described or not described in the other example embodiments. It should also be understood and appreciated that in other example embodiments, the flexible protection element 106 may comprise additional woven fabric elements, knitted fabric elements, intumescent elements, metal foil elements, and/or layers of woven fabric, knitted fabric, intumescent, metal foil, or other materials in the same or different sizes, shapes and arrangements.

In use, when an external force (F_{E}) is exerted on or acts upon the first woven fabric element 122A in a direction substantially perpendicular to the plane of the first woven fabric element 122A, the woven fabric elements 122 and metal foil element 164 tend to sag. Concurrently, the knitted fabric elements 124 tend to stretch as a stretchable element 166. Because the elasticity of the stretchable element 166 is at least five times larger than the elasticity of the metal foil element 164, the distortion due to the force (F_{E}) is primarily in the stretchable element 166 when the force (F_{E}) is acting. As used herein, the term “elasticity” refers to the relative elongation in the direction of an applied force divided by the applied force and normalized to the width of each relative element. Essentially, “elasticity” refers to the Hooke's field, i.e. the interval in which Hooke's approximation applies. If a Hooke's interval does not exist, the elasticity refers to the interval between zero (0) and one percent (1%) relative expansion. In this and other example embodiments herein, it is advantageous if the stretchable element 166 comprises a knitted fabric.

FIG. 19 displays a schematic, top plan view of a flexible protection element 106 in accordance with an example embodiment As illustrated in FIG. 19, the flexible protection element 106 has a first lateral edge 112A, an opposed second lateral edge 112B, and a general shape substantially similar to the flexible protection elements 106 of the other example embodiments described herein. The flexible protection element 106 of this example embodiment comprises a first knitted fabric layer 160A and a second knitted fabric layer 160B. The first knitted fabric layer 160A includes a knitted fabric element 124A that extends entirely between the first and second lateral edges 112A, 112B of the flexible protection element 106. The second knitted fabric layer 160B includes a knitted fabric element 124B that also extends entirely between the first and second lateral edges 112A, 112B of the flexible protection element 106. Thus, the first knitted fabric element 124A and the second knitted fabric element 124B extend substantially parallel to one another.

The flexible protection element 106 further comprises a metal foil element 164 that extends only partially between the first and second lateral edges 112A, 112B of the flexible protection element 106. The metal foil element 164 is positioned between the first and second knitted fabric elements 124A, 124B and is adjacent and substantially parallel thereto forming a multi-layer, sandwich structure. According to the current example embodiment, the metal foil element 164 is manufactured from high grade steel such as, for example and not limitation, V4A steel (also known as 1.440 steel). It should be understood and appreciated that the metal foil element 164 may be manufactured from other types of steels or metals in other example embodiments.

The knitted fabric elements 124A, 122B are coupled together by seams 128A, 128B formed with rows of stitches 130A, 130B using fire resistant thread 134 that are similar to the rows of stitches 130 used in seams 128 of the example embodiment described above in FIG. 6. It should be understood and appreciated, however, that seams 128A, 128B may alternatively use more rows of stitches, one or more stitching patterns, and one or more stitching arrangements as described or not described in the other example embodiments. It should also be understood and appreciated that in other example embodiments, the flexible protection element 106 may comprise additional knitted fabric elements and/or metal foil elements, woven fabric elements, intumescent elements, and/or layers of woven fabric, knitted fabric, intumescent, metal foil, or other materials in the same or different sizes, shapes and arrangements.

When an external force (F_{E}) is exerted on or acts upon the knitted fabric element 124A in a direction substantially perpendicular to the plane of the first knitted fabric element 124A, the knitted fabric elements 124 tend to stretch as a stretchable element 166 in the regions where the metal foil element 164 does not extend and is not present. Because the elasticity of the stretchable element 166 is considerably larger than the elasticity of the metal foil element 164, the distortion due to the force (F_{E}) is primarily in the stretchable element 166 when the force (F_{E}) is acting.

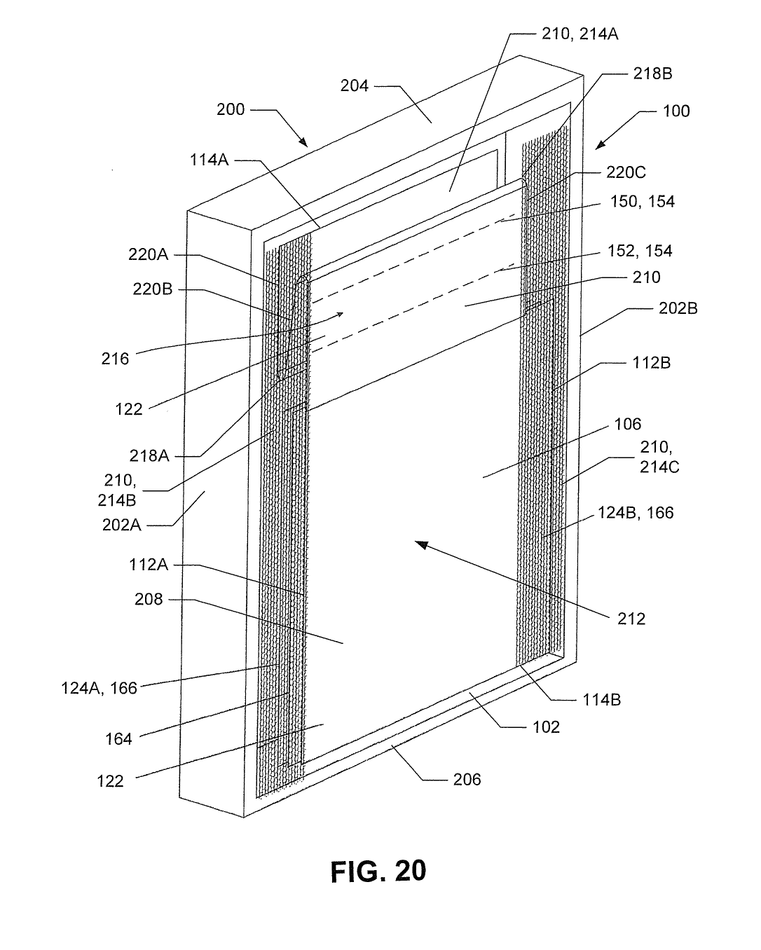

FIG. 20 displays a schematic, front perspective view of a flexible protection element 108 of a smoke or fire protection device 100, in accordance with an example embodiment, in an opening 102 through which the spread of fire and smoke is to be limited. The opening 102 is, for ease and purposes of illustration, defined by a frame 200. Other elements of the smoke or fire protection device 100 have been omitted from the view for clarity. The frame 200, as seen in FIG. 20 and for reference, includes a pair of opposed side panels 202A, 202B that extend longitudinally in the vertical direction, a top panel 204 that extends between the side panels 202A, 202B laterally in the horizontal direction, and an optional bottom panel 206 that also extends between the side panels 202A, 202B laterally in the horizontal direction.

The smoke or fire protection device 100 comprises a flexible protection element 106 that is gathered within and/or relative to the opening 102. The flexible protection element 106 has a first lateral edge 112A and an opposed second lateral edge 112B that extend in a generally longitudinal direction, and has a first longitudinal edge 114A and an opposed second longitudinal edge 114B that extend in a generally lateral direction between lateral edges 112A, 112B. The first longitudinal edge 114A of the flexible protection element 106 extends adjacent the frame's top panel 204 such that the flexible protection element 106 extends substantially entirely between the side panels 202A, 202B of the frame 200 with lateral edges 112A, 112B being substantially adjacent and parallel to respective inside surfaces of the frame's side panels 202A, 202B.

According to this current example embodiment, the flexible protection element 106 generally comprises a substantially non-stretchable portion 208 and a stretchable portion 210. The non-stretchable portion 208 has a generally rectangular shape when viewed from a direction perpendicular thereto indicated by arrow 212 and extends only partially between lateral edges 112A, 112B and longitudinal edges 114A, 114B. The non-stretchable portion 208 is surrounded on three sides by the stretchable portion 210 of the flexible protection element 106 such that a first section 214A of the stretchable portion 210 is present between the non-stretchable portion 208 and first longitudinal edge 114A and such that second and third sections 214B, 214C of the stretchable portion 210 are present, respectively, between the non-stretchable portion 208 and the first and second lateral edges 112A, 112B. The non-stretchable portion 208 has a multi-layer structure and includes first and second woven fabric elements 122A, 122B with a metal foil element 164 positioned therebetween. The first and second woven fabric elements 122A, 122B and metal foil element 164 are coupled together via seams formed using fire resistant thread 134 in a manner substantially similar to seams 128 of the other example embodiments described herein. The stretchable portion 210 of the flexible protection element 106 generally comprises a knitted fabric element 124 which stretches and is coupled to the non-stretchable portion 208 also by seams formed using fire resistant thread 134 in a manner substantially similar to seams 128 of the other example embodiments described herein.

The first section 214A of the stretchable portion 210 of the flexible protection element 106 forms a gathered portion 216 (also sometimes referred to herein as a “folded portion 216” or “overlapping portion 216”) relatively near the inside surface of the frame's top panel 204 and the element's first longitudinal edge 114A. To form the gathered portion 216, the first section 214A of the stretchable portion 210 is folded along fold lines 218A, 218B extending between lateral edges 112A, 112B and overlapped to define a first part 220A of the gathered portion 216 extending from the element's first longitudinal edge 114A to the first fold line 218A in a direction generally toward the elements second longitudinal edge 114B, a second part 220B of the gathered portion 216 extending between the first fold line 218A and the second fold line 218B in a direction generally toward the element's first longitudinal edge 114A, and a third part of the gathered portion 216 extending in a direction generally toward the element's second longitudinal edge 114B. Thus, in the gathered portion 216, the second part 220B of the gathered portion 216 is oriented substantially adjacent to and overlaps a portion of the first part 220A of the gathered portion 216. Similarly, a portion of the third part 220C of the gathered portion 216 is oriented substantially adjacent to and overlaps the second part 220B of the gathered portion 216. Collectively, the first, second and third parts 220A, 220B, 220C form a “Z-shaped” folding pattern when viewed from one of the lateral edges 112 of the flexible protection element 106.

In order to maintain the first, second and third parts 220A, 220B, 220C of the gathered portion 216 so arranged and in the storage arrangement, a seam 128 is formed using rows of stitches 150, 152 to releasably couple the parts 220 together. The rows of stitches 150, 152 are made with non-fire resistant thread 154. During exposure of the flexible protection element 106 to fire, the stretchable portion 210 stretches and coupled with the fire causes the rows of stitches 150, 152 to become undone or destroyed, thereby permitting the gathered portion 216 to come undone and allowing the force of gravity to act on parts 220B, 220C to tin-gather the flexible protection element 106.

Once un-gathered, the stretchable portion 210 and, hence, the flexible protection element 108 have increased surface area with which to receive, distribute, and absorb a force exerted on the flexible protection element 108. Also, the first, second and third parts 220A, 220B, 220C of the first section 214A of the stretchable portion 210 may stretch and yield, since they are formed of a stretchable material, in response to a force exerted on the flexible protection element 108. Additionally, the second and third sections 214B, 214C of the stretchable portion 210 present, respectively, between the non-stretchable portion 208 and the first and second lateral edges 112A, 112B may also stretch and yield, since they are formed of a stretchable material, in response to force applied to the flexible protection element 108. Thus, at least by virtue of the un-gathering of the first section 214A of the stretchable portion 210 and the presence of the second and third sections 214B, 214C of the stretchable portion 210, the flexible protection element 108 is reconfigurable into a configuration that is more able to stretch and bulge in a direction normal to the surface of the flexible protection element 108 and, hence, better resist forces applied to the flexible protection element 108, including, but not limited to, forces corresponding to a stream of water from a fire hose.

In addition, because the first section 214A of the stretchable portion 210 is initially gathered, the stretchable portion 210 and the flexible protection element 106 may be sized to be much larger and have substantially greater surface area in the un-gathered configuration. Further, the ability of the flexible protection element 106 to resist force is not solely dependent upon the stretchability and elastic properties of the materials employed therein.

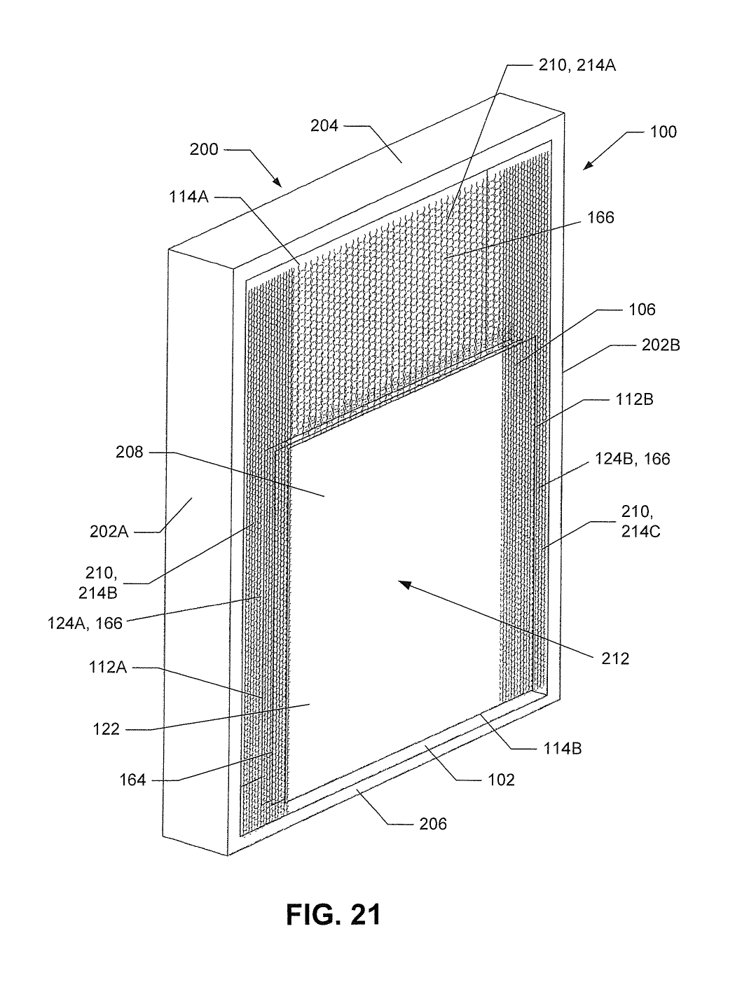

FIG. 21 displays a schematic, front perspective view of a flexible protection element of a smoke or fire protection device 100, in accordance with an example embodiment, in an opening through which the spread of fire and smoke is to be limited. The flexible protection element 106 is substantially similar to the flexible protection element 106 of the example embodiment depicted in FIG. 20, is displayed using a similar frame 200 and opening 102, and comprises a flexible protection element 106 having a non-stretchable portion 208 and a coupled non-stretchable portion 210.

Similar to the previous example embodiment illustrated in FIG. 20, the non-stretchable portion 208 has a generally rectangular shape when viewed from a direction perpendicular thereto indicated by arrow 212 and extends only partially between lateral edges 112A, 112B and longitudinal edges 114A, 114B of the flexible protection element 106. The non-stretchable portion 208 is surrounded on three sides by the stretchable portion 210 of the flexible protection element 106 such that a first section 214A of the stretchable portion 210 is present between the non-stretchable portion 208 and first longitudinal edge 114A and such that second and third sections 214B, 214C of the stretchable portion 210 are present, respectively, between the non-stretchable portion 208 and the first and second lateral edges 112A, 112B of the flexible protection element 106. The non-stretchable portion 208 has a multi-layer structure and includes first and second woven fabric elements 122A, 122B with a metal foil element 164 positioned there between. The first and second woven fabric elements 122A, 122B and metal foil element 164 are coupled together via seams formed using fire resistant thread 134 in a manner substantially similar to seams 128 of the other example embodiments described herein.

The stretchable portion 210 of the flexible protection element 106 generally comprises a knitted fabric element 124 and is coupled to the non-stretchable portion 208 also by seams formed using fire resistant thread 134 in a manner substantially similar to seams 128 of the other example embodiments described herein. However, in contrast to the flexible protection element 106 of the example embodiment shown in FIG. 20, the first section 214A of the stretchable portion 210 is not formed into a gathered portion. Therefore, during exposure to fire, there is no gathered portion to come undone to enhance the surface area or the stretching and deflection capabilities of the flexible protection element 106. Hence, stretching and deflection of the flexible protection element 106 responsive to an applied force is substantially due to stretching and bulging of the knitted fabric element 124 comprising the stretchable portion 210 thereof.

As described above, the flexible protection elements 106 generally each comprise a sheet-like member that extends substantially between the lateral and longitudinal edges of an opening through which the spread of fire and smoke is to be limited. However, in certain applications and sometimes due to manufacturing considerations, it is advantageous for some flexible protection elements 106 to be configured as a plurality of transverse strips 230 with each transverse strip 230 having a substantially rectangular shape (when viewed in a direction perpendicular to a front or back surface thereof) and being relatively thin in thickness as compared the lateral and longitudinal dimensions thereof. When a flexible protection element 106 is so configured, elongate clamping members 232 couple adjacent pairs of transverse strips 230 of the flexible protection element 106 together. Generally, the elongate clamping members 232 extend primarily in and parallel to the longitudinal edges 114 of a flexible protection element 106, and may advantageously extend beyond the lateral edges 112 thereof such that the elongate clamping members 232 extend into the recesses of the lead tracks 110. Also, each elongate clamping member 232 is typically located at a distance of less than two (2) meters relative to each immediately preceding and succeeding elongate clamping members 232. More accurately, each elongate clamping member 232 is located at a distance of between thirty (30) to one hundred (100) centimeters relative to each immediately preceding and succeeding elongate clamping members 232, with a preferred distance measuring fifty (50) centimeters.

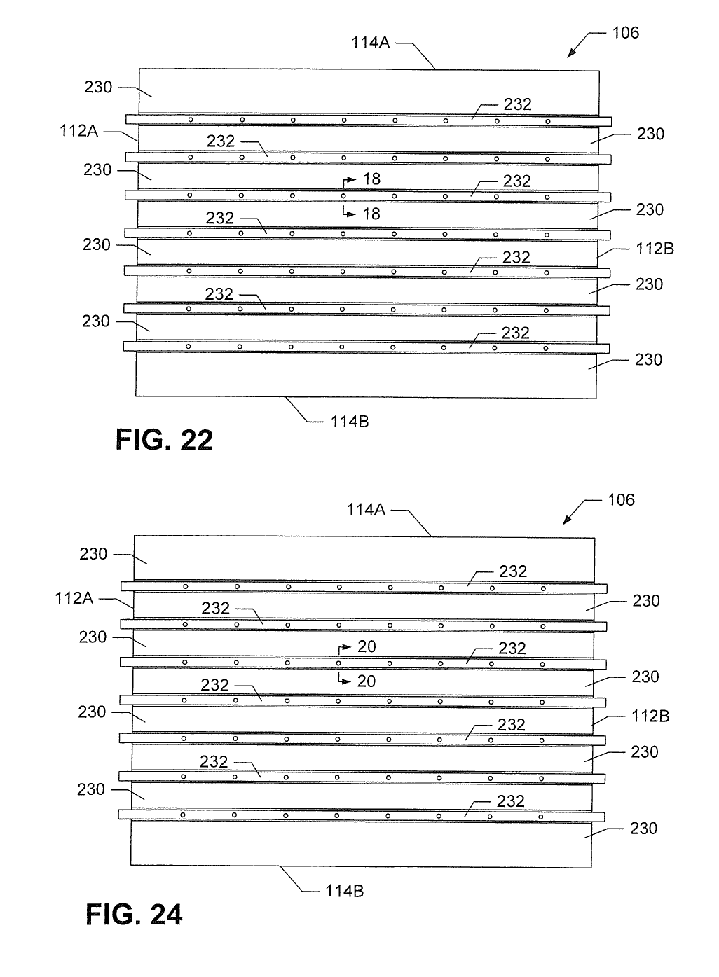

Beneficially, the elongate clamping members 232 permit a flexible protection element 106 to be wound onto a winding shaft 108 for configuration of a smoke or fire protection device 100 in a storage arrangement or to be unwound from a winding shaft 108 for reconfiguration of a smoke or fire protection device 100 in a protection arrangement as the elongate clamping members 232 also typically extend in a direction parallel to the longitudinal axis of the winding shaft 108. Also, the elongate clamping members 232 are relatively stable against downward deflection and, hence, aid the flexible protection element 106 in maintaining its shape and in opposing sagging. Additionally, the elongate clamping members 232 are generally easy to install, which is important since flexible protection elements 106 using elongate clamping members 232 are assembled at job sites. In the paragraphs that follow, a number of different elongate clamping members 232 are described in further detail with respect to FIGS. 22-34.

FIG. 22 displays a schematic, partial, front elevational view of a flexible protection element 106 having elongate clamping members 232 in accordance with an example embodiment. As seen in FIG. 22, the flexible protection element 106 has a first lateral edge 112A, an opposed second lateral edge 112B, a first longitudinal edge 114A, and an opposed second longitudinal edge 114B. The flexible protection element 106 comprises a plurality of transverse strips 230 with each transverse strip 230 extending between lateral edges 112A, 112B. Each transverse strip 230 is formed from a single layer of fire resistant material including, for example, but not limitation, the knitted fabric, woven fabric, metal foil, and other fire resistant materials described, or not described, herein. The flexible protection element 106 further comprises a plurality of elongate clamping members 232 with each elongate clamping member 232 extending between and coupling adjacent transverse strips 230 and extending between lateral edges 112A, 112B.

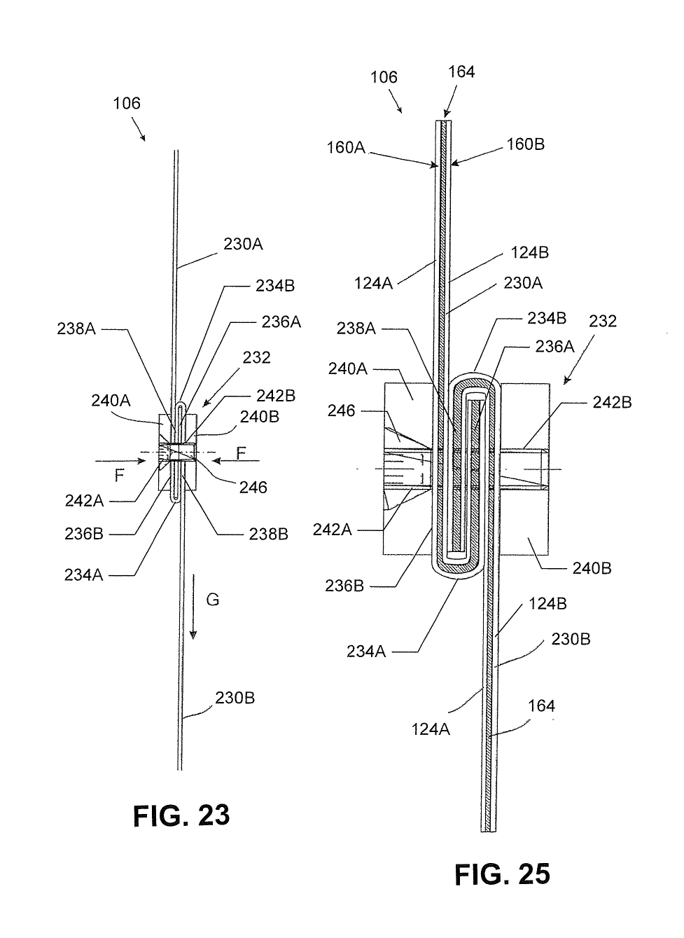

FIG. 23 displays a schematic, cross-sectional view of an elongate clamping member 232 of the flexible protection element 106 of FIG. 22 taken along lines 18-18 and showing portions of the adjacent transverse strips 230A, 230B. As illustrated in FIG. 23, transverse strip 230A is folded along fold line 234A to define first and second portions 236A, 236B of transverse strip 230A in a substantially “U-shape” configuration. Similarly, transverse strip 230B is folded along fold line 234B to define first and second portions 238A, 238B in a substantially “U-shape” configuration. Transverse strip 230A and transverse strip 230B are arranged such that the first portion 236A of transverse strip 230A resides between the first portion 238A of transverse strip 230B and the second portion 238B of transverse strip 230B. Similarly, the first portion of 238A of transverse strip 230B resides between the first portion 236A of transverse strip 230A and the second portion 236B of transverse strip 230A. Frictional forces between portions 236A, 236B of transverse strip 230A and portions 238A, 238B of transverse strip 230B aid in holding the transverse strips 230A, 230B together and resisting forces that tend to cause separation. To enhance the frictional forces, a strip made of non-flammable material and having rough surfaces may be positioned between portions 236A, 236B of transverse strip 230A and portions 238A, 238B of transverse strip 230B.

The elongate clamping member 232 comprises a first elongate clamping rod 240A and an opposed second elongate clamping rod 240B. The first elongate clamping rod 240A resides adjacent the second portion 236B of transverse strip 230A and defines a plurality of bores 242A that are laterally offset relative to one another at a respective plurality of discrete locations between the lateral edges 112A, 112B of the flexible protection element 106. Similarly, the second elongate clamping rod 240B resides adjacent the second portion 238B of transverse strip 230B and defines a plurality of bores 242B that are laterally offset relative to one another at a respective plurality of discrete locations between lateral edges 112A, 112B axially-aligned with bores 242A of the first elongate clamping rod 240A. Transverse strips 230A, 230B similarly define a plurality of bores 244 extending through portions 236A, 238A and parts of portions 236B, 238B at a respective plurality of discrete locations between lateral edges 112A, 112B and that are, respectively, cooperative and coaxially-aligned with respective bores 242A, 242B. The elongate clamping member 232 further comprises a plurality of pre-tensioning members 246 such that a respective pre-tensioning member 246 is present within coaxially-aligned bores 242A, 242B, 244. The pre-tensioning members 246 apply a pre-tensioning force (F_{P}) to the first and second elongate clamping rods 240 pre-tensioning the elongate clamping rods 240 relative to one another and causing the elongate clamping rods 240A, 240B to securely hold portions 236A, 238A and parts of portions 236B, 238B of adjacent transverse strips 230A, 230B together. Pre-tensioning members 246 acceptable in accordance with this example embodiment include, for example and not limitation, fasteners, rivets, tie rods, screws, and tension springs. Generally, the pre-tensioning force (F_{P}) is selected to hold adjacent transverse strips 230A, 230B together when a load force (G) corresponding to twice the weight of the components of the flexible protection element 106 present below the elongate clamping member 232 is applied.

It should be understood and appreciated that clamping of adjacent elongate members 230A, 230B together constitutes an improvement over coupling of the elongate members 230A, 230B with seams. Thus, although adjacent transverse strips 230A, 230B are punctured in connection with use of the elongate clamping members 232 and, hence, the transverse strips 230A, 230B are weakened, the mechanical weakening of the flexible protection element 106 due to seaming is substantially greater.

FIG. 24 displays a schematic, partial, front elevational view of a flexible protection element 106 having elongate clamping members 232 in accordance with an example embodiment. As seen in FIG. 24, the flexible protection element 106 has a first lateral edge 112A, an opposed second lateral edge 112B, a first longitudinal edge 114A, and an opposed second longitudinal edge 114B. The flexible protection element 106 comprises a plurality of transverse strips 230 with each transverse strip 230 extending between lateral edges 112A, 112B. Each transverse strip 230 is formed from and includes a first knitted fabric element 124A, a metal foil element 164, and a second knitted fabric element 124B arranged in a multi-layer sandwich structure. The flexible protection element 106 further comprises a plurality of elongate clamping members 232 with each elongate clamping member 232 extending between and coupling adjacent transverse strips 230 and extending between lateral edges 112A, 112B. It should be understood and appreciated that each transverse strip 230 may also be formed using any of the materials and according to any of the structures for flexible protection elements 106 described, or not described, herein.

FIG. 25 displays a schematic, cross-sectional view of an elongate clamping member 232 of the flexible protection element 106 of FIG. 25 taken along lines 20-20 and showing portions of the adjacent transverse strips 230A, 230B. As illustrated in FIG. 25, transverse strip 230A is folded along fold line 234A to define first and second portions 236A, 236B of transverse strip 230A in a substantially “U-shape” configuration. Similarly, transverse strip 230B is folded along fold line 234B to define first and second portions 238A, 238B in a substantially “U-shape” configuration. Transverse strip 230A and transverse strip 230B are arranged such that the first portion 236A of transverse strip 230A resides between the first portion 238A of transverse strip 230B and the second portion 238B of transverse strip 230B. Similarly, the first portion of 238A of transverse strip 230B resides between the first portion 236A of transverse strip 230A and the second portion 236B of transverse strip 230A. Frictional forces between portions 236A, 236B of transverse strip 230A and portions 238A, 238B of transverse strip 230B aid in holding the transverse strips 230A, 230B together and resisting forces that tend to cause separation.

The elongate clamping member 232 comprises a first elongate clamping rod 240A and an opposed second elongate clamping rod 240B. The first elongate clamping rod 240A resides adjacent the second portion 236B of transverse strip 230A and defines a plurality of bores 242A that are laterally offset relative to one another at a respective plurality of discrete locations between the lateral edges 112A, 112B of the flexible protection element 106. Similarly, the second elongate clamping rod 240B resides adjacent the second portion 238B of transverse strip 230B and defines a plurality of bores 242B that are laterally offset relative to one another at a respective plurality of discrete locations between lateral edges 112A, 112B axially-aligned with bores 242A of the first elongate clamping rod 240A. Transverse strips 230A, 230B similarly define a plurality of bores 244 extending through portions 236A, 238A and parts of portions 236B, 238B at a respective plurality of discrete locations between lateral edges 112A, 112B and that are, respectively, cooperative and coaxially-aligned with respective bores 242A, 242B. The elongate clamping member 232 further comprises a plurality of pre-tensioning members 246 such that a respective pre-tensioning member 246 is present within coaxially-aligned bores 242A, 242B, 244. The pre-tensioning members 246 apply a pre-tensioning force (F_{P}) to the first and second elongate clamping rods 240 pre-tensioning the elongate clamping rods 240 relative to one another and causing the elongate clamping rods 240A, 240B to securely hold portions 236A, 238A and parts of portions 236B, 238B of adjacent transverse strips 230A, 230B together. Pre-tensioning members 246 acceptable in accordance with this example embodiment include, for example and not limitation, fasteners, rivets, tie rods, screws, and tension springs.

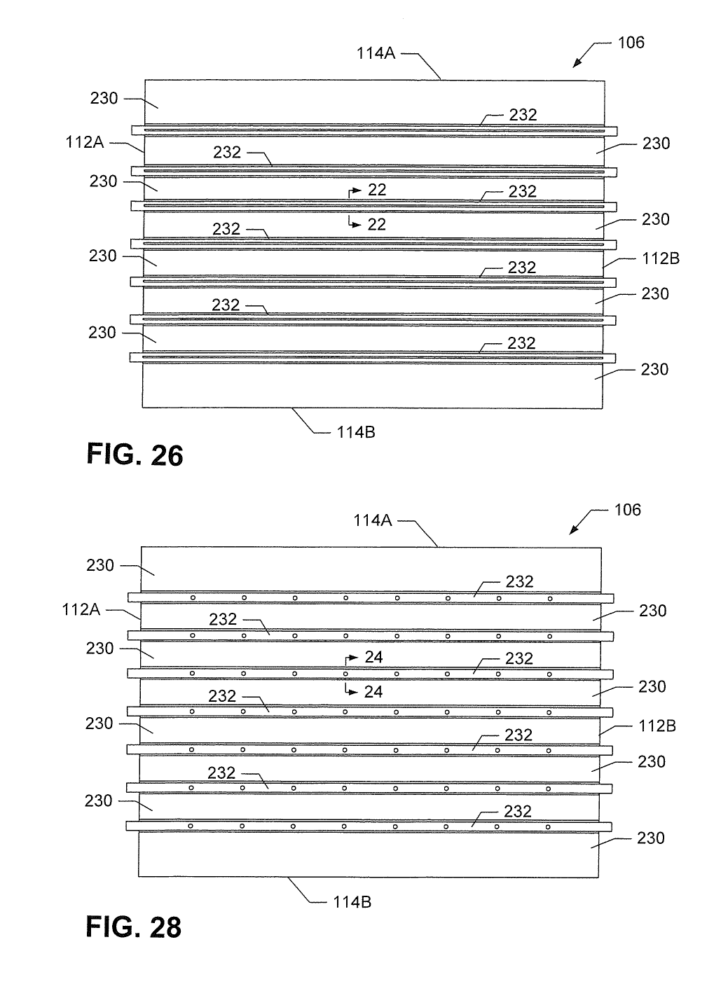

FIG. 26 displays a schematic, partial, front elevational view of a flexible protection element 106 having elongate clamping members 232 in accordance with an example embodiment. As seen in FIG. 26, the flexible protection element 106 has a first lateral edge 112A, an opposed second lateral edge 112B, a first longitudinal edge 114A, and an opposed second longitudinal edge 114B. The flexible protection element 106 comprises a plurality of transverse strips 230 with each transverse strip 230 extending between lateral edges 112A, 112B. Each transverse strip 230 is formed from a single layer of fire resistant material including, for example, but not limitation, the knitted fabric, woven fabric, metal foil, and other fire resistant materials described, or not described, herein. The flexible protection element 106 further comprises a plurality of elongate clamping members 232 with each elongate clamping member 232 extending between and coupling adjacent transverse strips 230 and extending between lateral edges 112A, 112B.

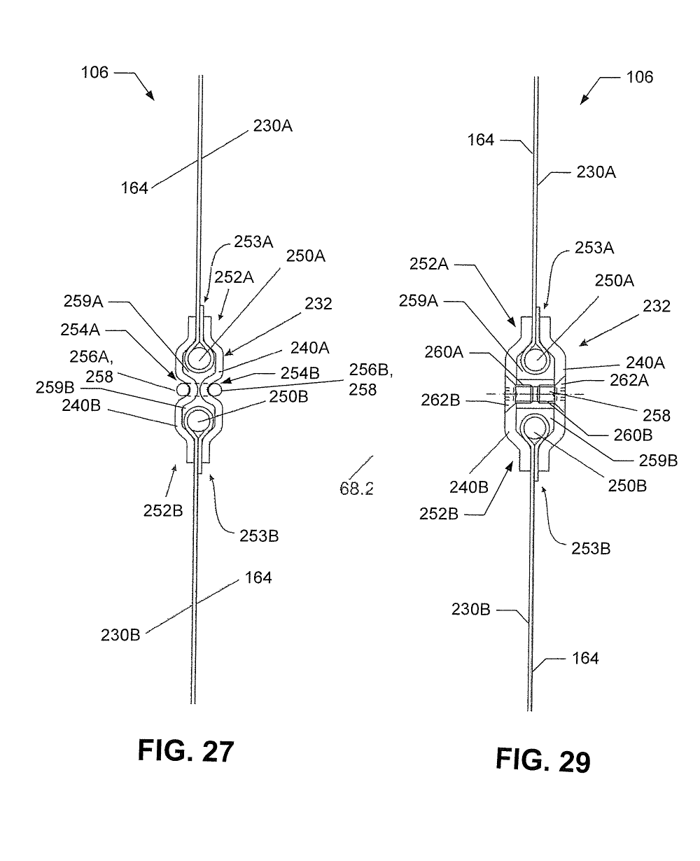

FIG. 27 displays a schematic, cross-sectional view of an elongate clamping member 232 of the flexible protection element 106 of FIG. 26 taken along lines 22-22 and showing portions of the adjacent transverse strips 230A, 230B. As illustrated in FIG. 27, elongate clamping member 232 comprises a first elongate piping/welt member 250A and an opposed second elongate piping/welt member 250B that each extend between the lateral edges 112A, 112B of the flexible protection element 106. A portion of transverse strip 230A wraps around the first elongate piping/welt member 250A to form a first elongate piping/welt 252A and first elongate loop 253A extending between the lateral edges 112A, 112B of the flexible protection element 106. Similarly, a portion of transverse strip 230B wraps around the second elongate piping/welt member 250B to form a second elongate piping/welt 252B and second elongate loop 253B extending between the lateral edges 112A, 112B of the flexible protection element 106.

The elongate clamping member 232 further comprises a first elongate clamping rod 240A and an opposed second elongate clamping rod 240B. The first and second elongate clamping rods 240A, 240B define respective elongate recesses 254A, 254B for receiving respective portions 256A, 256B of an elongate retaining member 258 therein. The elongate retaining member 258 locks the first elongate clamping rod 240A to the second elongate clamping rod 240B. When locked together, the first and second elongate clamping rods 240A, 240B define elongate piping/welt cavities 259A, 259B extending between the lateral edges 112A, 112B of the flexible protection element 106 in which the first and second elongate piping/welts 252A, 252B respectively reside, thereby coupling transverse strips 230A, 230B.

It should be understood and appreciated that while each transverse strip 230 has been described with reference to FIGS. 26 and 27 as being formed by a single layer of fire resistant material, each transverse strip 230 may also be formed using any of the materials and according to any of the structures (including, without limitation, the multi-layer structures) for flexible protection elements 106 described, or not described, herein. It should also be understood and appreciated that the elongate clamping member of FIGS. 26 and 27 may be employed with transverse strips 230 employing single layers of fire resistant materials or employing multi-layer structures having one or more fire resistant materials. Additionally, it should be understood and appreciated that if the transverse strips 230 are formed of metal foil elements 164, the transverse strips 230A, 230B may be wrapped respectively around the first and second elongate piping/welt members 250A, 250B and welded respectively to themselves to form very stable elongate piping/welts 252A, 252B. Further, if such elongate piping/welts 252A, 252B are formed, a clasp may be employed in lieu of elongate clamping member 232 resulting in a particularly secure connection between the transverse strips 230A, 230B.

FIG. 28 displays a schematic, partial, front elevational view of a flexible protection element 106 having elongate clamping members 232 in accordance with an example embodiment. As seen in FIG. 28, the flexible protection element 106 has a first lateral edge 112A, an opposed second lateral edge 112B, a first longitudinal edge 114A, and an opposed second longitudinal edge 114B. The flexible protection element 106 comprises a plurality of transverse strips 230 with each transverse strip 230 extending between lateral edges 112A, 112B. Each transverse strip 230 is faulted from a single layer of fire resistant material including, for example, but not limitation, the knitted fabric, woven fabric, metal foil, and other fire resistant materials described, or not described, herein. The flexible protection element 106 further comprises a plurality of elongate clamping members 232 with each elongate damping member 232 extending between and coupling adjacent transverse strips 230 and extending between lateral edges 112A, 112B.

FIG. 29 displays a schematic, cross-sectional view of an elongate clamping member 232 of the flexible protection element 106 of FIG. 28 taken along lines 24-24 and showing portions of the adjacent transverse strips 230A, 230B. As illustrated in FIG. 29, elongate clamping member 232 comprises a first elongate piping/welt member 250A and an opposed second elongate piping/welt member 250B that each extend between the lateral edges 112A, 112B of the flexible protection element 106. A portion of transverse strip 230A wraps around the first elongate piping/welt member 250A to form a first elongate piping/welt 252A and first elongate loop 253A extending between the lateral edges 112A, 112B of the flexible protection element 106. Similarly, a portion of transverse strip 230B wraps around the second elongate piping/welt member 250B to form a second elongate piping/welt 252B and second elongate loop 253B extending between the lateral edges 112A, 112B of the flexible protection element 106.

The elongate clamping member 232 further comprises a first elongate clamping rod 240A and an opposed second elongate clamping rod 240B. The first and second elongate clamping rods 240A, 240B define respective coaxially-aligned bores 260A, 260B for receiving fasteners 262A, 262B therein. The fasteners 262A, 262B lock the first elongate clamping rod 240A to the second elongate clamping rod 240B. When locked together, the first and second elongate clamping rods 240A, 240B define elongate piping/welt cavities 259A, 259B extending between the lateral edges 112A, 112B of the flexible protection element 106 in which the first and second elongate piping/welts 252A, 252B respectively reside, thereby coupling transverse strips 230A, 230B.

It should be understood and appreciated that while each transverse strip 230 has been described with reference to FIGS. 28 and 29 as being formed by a single layer of fire resistant material, each transverse strip 230 may also be formed using any of the materials and according to any of the structures (including, without limitation, the multi-layer structures) for flexible protection elements 106 described, or not described, herein. It should also be understood and appreciated that the elongate clamping member of FIGS. 28 and 29 may be employed with transverse strips 230 employing single layers of fire resistant materials or employing multi-layer structures having one or more fire resistant materials. Additionally, it should be understood and appreciated that if the transverse strips 230 are formed of metal foil elements 164, the transverse strips 230A, 230B may be wrapped respectively around the first and second elongate piping/welt members 250A, 250B and welded respectively to themselves to form very stable elongate piping/welts 252A, 252B.

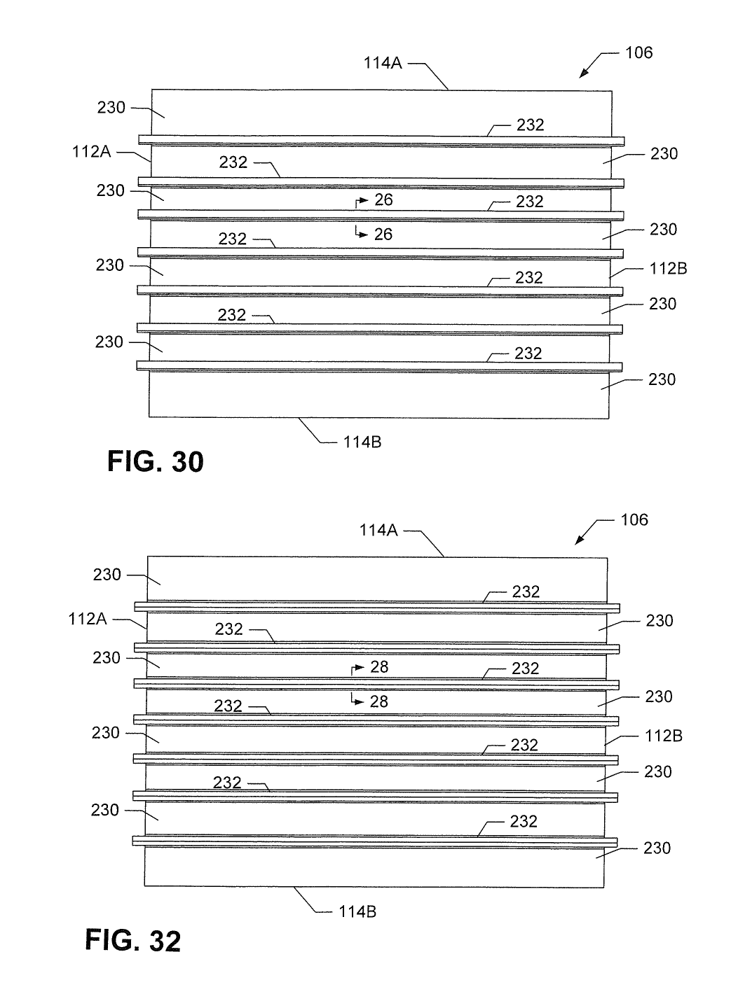

FIG. 30 displays a schematic, partial, front elevational view of a flexible protection element 106 having elongate clamping members 232 in accordance with a twentieth example embodiment. As seen in FIG. 30, the flexible protection element 106 has a first lateral edge 112A, an opposed second lateral edge 112B, a first longitudinal edge 114A, and an opposed second longitudinal edge 114B. The flexible protection element 106 comprises a plurality of transverse strips 230 with each transverse strip 230 extending between lateral edges 112A, 112B. Each transverse strip 230 is formed from a single layer of fire resistant material including, for example, but not limitation, the knitted fabric, woven fabric, metal foil, and other fire resistant materials described, or not described, herein. The flexible protection element 106 further comprises a plurality of elongate clamping members 232 with each elongate clamping member 232 extending between and coupling adjacent transverse strips 230 and extending between lateral edges 112A, 112B.

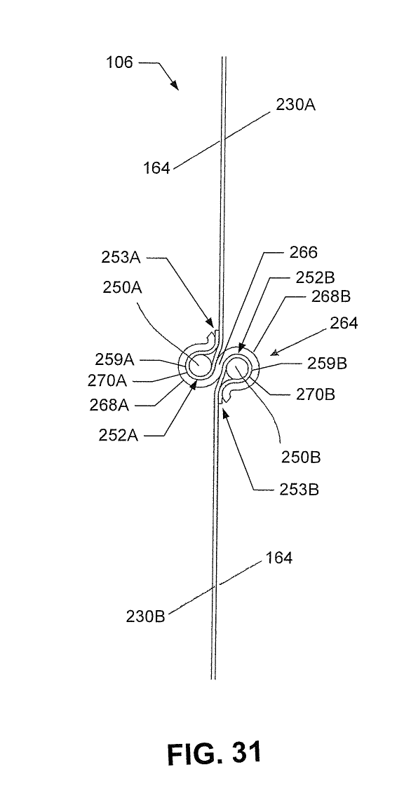

FIG. 31 displays a schematic, cross-sectional view of an elongate clamping member 232 of the flexible protection element 106 of FIG. 30 taken along lines 26-26 and showing portions of the adjacent transverse strips 230A, 230B. As illustrated in FIG. 31, elongate clamping member 232 comprises a first elongate piping/welt member 250A and an opposed second elongate piping/welt member 250B that each extend between the lateral edges 112A, 112B of the flexible protection element 106. A portion of transverse strip 230A wraps around the first elongate piping/welt member 250A to form a first elongate piping/welt 252A extending between the lateral edges 112A, 112B of the flexible protection element 106. Similarly, a portion of transverse strip 230B wraps around the second elongate piping/welt member 250B to form a second elongate piping/welt 252B extending between the lateral edges 112A, 112B of the flexible protection element 106.

The elongate clamping member 232 further comprises an elongate clamping clip 264 extending slightly beyond the lateral edges 112A, 112B of the flexible protection element 106. The elongate clamping clip 264 has an elongate central portion 266 and an elongate first leg 268A that extends away from the elongate central portion 266 and then loops back toward the elongate central portion 266 to define a first elongate channel 270A. The elongate clamping clip 264 also has an elongate second leg 268B that, similar to the elongate first leg 268A but in the opposite direction, extends away from the elongate central portion 266 and then loops back toward the elongate central portion 266 to define a second elongate channel 270B. Collectively, the elongate central portion 266, elongate first leg 268A, and elongate second leg 268B form a cross-sectional shape corresponding to a tilted letter “S.” The first and second elongate channels 270A, 270B respectively receive the first and second elongate piping/welts 252A, 252B.

The elongate clamping clip 264 is manufactured, according to the example embodiment, from a fire resistant, spring steel material that permits the ends of the elongate first and second legs 268A, 268B to be respectively spread apart from the elongate central portion 266 for the insertion of the first and second elongate piping/welts 252A, 252B into the first and second elongate channels 270A, 270B. Once the elongated piping/welts 252 are inserted, the elongate first and second legs 268A, 268B spring back toward the elongate central portion 266 securing the elongated piping/welts 252 and trapping respective portions of the transverse strips 230A, 230B there between. Also, the elongate piping/welts 252A, 252B are positioned at respective locations offset forward and aft from the plane of the transverse strips 230A, 230B.

It should be understood and appreciated that while each transverse strip 230 has been described with reference to FIGS. 30 and 31 as being formed by a single layer of fire resistant material, each transverse strip 230 may also be formed using any of the materials and according to any of the structures (including, without limitation, the multi-layer structures) for flexible protection elements 106 described, or not described, herein. It should also be understood and appreciated that the elongate clamping member of FIGS. 30 and 31 may be employed with transverse strips 230 employing single layers of fire resistant materials or employing multi-layer structures having one or more fire resistant materials. Additionally, it should be understood and appreciated that if the transverse strips 230 are formed of metal foil elements 164, the transverse strips 230A, 230B may be wrapped respectively around the first and second elongate piping/welt members 250A, 250B and welded respectively to themselves to form very stable elongate piping/welts 252A, 252B.

FIG. 32 displays a schematic, partial, front elevational view of a flexible protection element 106 having elongate clamping members 232 in accordance with an example embodiment. As seen in FIG. 32, the flexible protection element 106 has a first lateral edge 112A, an opposed second lateral edge 112B, a first longitudinal edge 114A, and an opposed second longitudinal edge 114B. The flexible protection element 106 comprises a plurality of transverse strips 230 with each transverse strip 230 extending between lateral edges 112A, 112B. Each transverse strip 230 is formed from a single layer of fire resistant material including, for example, but not limitation, the knitted fabric, woven fabric, metal foil, and other fire resistant materials described, or not described, herein. The flexible protection element 106 further comprises a plurality of elongate clamping members 232 with each elongate clamping member 232 extending between and coupling adjacent transverse strips 230 and extending between lateral edges 112A, 112B.

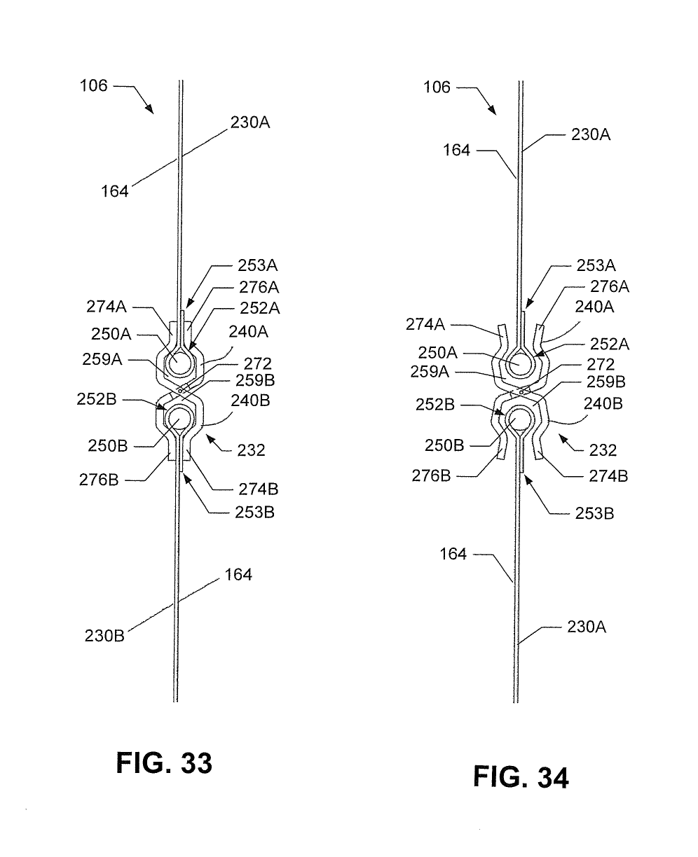

FIG. 33 displays a schematic, cross-sectional view of an elongate clamping member 232 of the flexible protection element 106 of FIG. 32 taken along lines 28-28 and showing portions of the adjacent transverse strips 230A, 230B. The elongate clamping member 232 is configurable in first, closed configuration (see FIG. 33) in which adjacent transverse strips 230A, 230B are clamped and coupled together, and a second, open configuration (see FIG. 34) in which adjacent transverse strips 230A, 230B are not clamped or coupled together. As illustrated in FIG. 33, elongate clamping member 232 comprises a first elongate piping/welt member 250A and an opposed second elongate piping/welt member 250B that each extend between the lateral edges 112A, 112B of the flexible protection element 106. A portion of transverse strip 230A wraps around the first elongate piping/welt member 250A to form a first elongate piping/welt 252A and elongate loop 253A extending between the lateral edges 112A, 112B of the flexible protection element 106. Similarly, a portion of transverse strip 230B wraps around the second elongate piping/welt member 250B to form a second elongate piping/welt 252B and elongate loop 253B extending between the lateral edges 112A, 112B of the flexible protection element 106.

The elongate clamping member 232 also comprises a first elongate clamping rod 240A and a second elongate clamping rod 240B pivotally, or hingedly, attached to the first elongate clamping rod 240A in a scissor or criss-cross arrangement via an elongate pivot pin 272. The first elongate clamping rod 240A has an elongate first part 274A and an elongate second part 274B. Similarly, the second elongate clamping rod 240B has an elongate first part 276A and an elongate second part 276B.

Additionally, the elongate clamping member 232 defines first and second elongate piping/welt cavities 259A, 259B extending between the lateral edges 112A, 112B of the flexible protection element 106 for respectively receiving first and second elongate piping/welts 252A, 252B. More specifically, the elongate first part 274A of first elongate clamping rod 240A and the elongate first part 276A of second elongate clamping rod 240B form the first elongate piping/welt cavity 259A. Similarly, the elongate second part 274B of first elongate clamping rod 240A and the elongate second part 276B of second elongate clamping rod 240B form the second elongate piping/welt cavity 259B.

In use, the first elongate clamping rod 240A and second elongate clamping rod 240B are pivoted relative to one another about pivot pin 272 to configure the elongate clamping member 232 in the open configuration. The first and second elongate piping/welts 252A, 252B are then respectively inserted into and received by the first and second elongate piping/welt cavities 258A, 258B. Subsequently, the first elongate clamping rod 240A and second elongate clamping rod 240B are again pivoted relative to one another about pivot pin 272, but to configure the elongate clamping member 232 in the closed configuration. Once configured and secured in the closed configuration, for example and not limitation, by a biasing member or locking mechanism, the first and second elongate clamping rods 240A, 240B contact, or engage, transverse strips 230A, 230B and hold the first and second elongate piping/welts 252A, 252B within the first and second elongate piping/welt cavities 258A, 258B to securely couple transverse strips 230A, 230B.

The elongated clamping member 232 of this example embodiment is particularly well-suited for use with transverse strips 230 including one or more metal foil element(s) 164 that comprise at least one layer of metal foil material. If the transverse strips 230 are formed of metal foil elements 164, the transverse strips 230A, 230B may be wrapped respectively around the first and second elongate piping/welt members 250A, 250B and welded respectively to themselves to form very stable elongate piping/welts 252A, 252B.

It should be understood and appreciated that while each transverse strip 230 has been described with reference to FIGS. 32, 33 and 34 as being formed by a single layer of fire resistant material, each transverse strip 230 may also be formed using any of the materials and according to any of the structures (including, without limitation, the multi-layer structures) for flexible protection elements 106 described, or not described, herein. It should also be understood and appreciated that the elongate clamping member of FIGS. 32, 33 and 34 may be employed with transverse strips 230 employing single layers of fire resistant materials or employing multi-layer structures having one or more fire resistant materials.

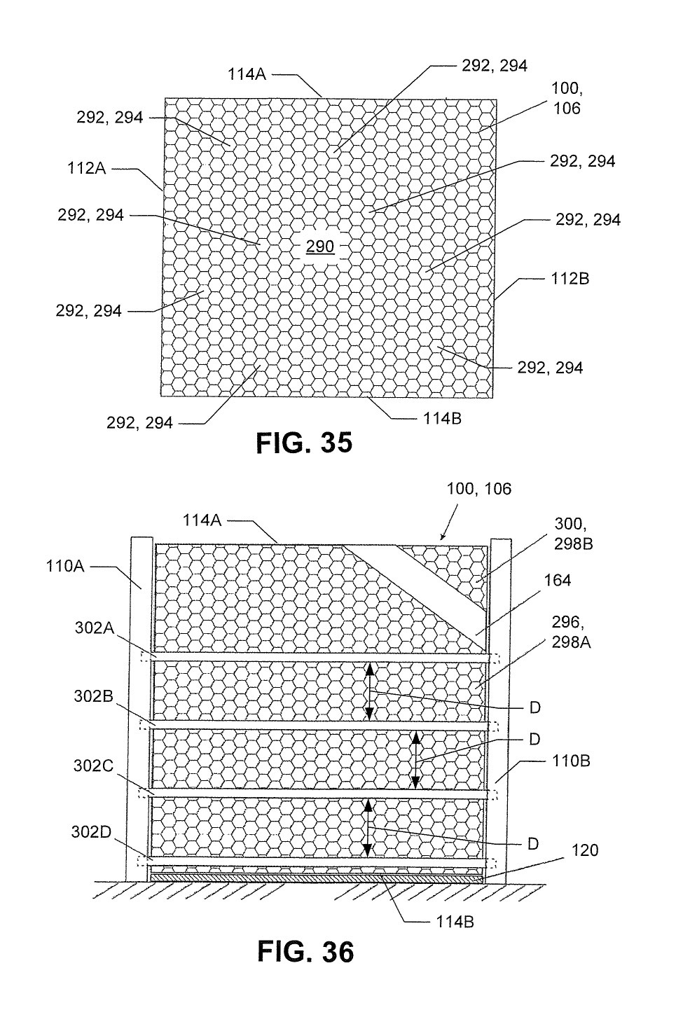

In the previously described example embodiments of a smoke or fire protection device 100 and/or various components thereof, the flexible protection elements 106 have been manufactured with substantially smooth front and back surfaces. However, if the flexible protection elements 106 are made with front and/or back surfaces having a pattern imprinted or embossed therein, the flexible protection elements 106 deform and bulge in a malleable way locally in the areas of the imprinted or embossed pattern elements so that the imprint or embossed pattern elements yield, thereby increasing the resistance to forces applied normal to the surfaces. Therefore, in the example embodiments described below with reference to FIGS. 35, 36 and 37, the flexible protection elements 106 are manufactured with front and/or back surfaces having a pattern or a texture.

FIG. 35 displays a schematic, front elevational view of a flexible protection element 106 of a smoke or fire protection device 100 in accordance with an example embodiment. The flexible protection element 106, as seen in FIG. 35, has a first lateral edge 112A and an opposed second lateral edge 112B that each extend in a substantially longitudinal direction. The flexible protection element 106 also has a first longitudinal edge 114A and an opposed second longitudinal edge 114B that each extend in a substantially lateral direction between lateral edges 112A, 112B. Generally, the flexible protection element 106 comprises a sheet-like member that is minimal in thickness (as measured between front and back surfaces thereof) relative to the element's lateral and longitudinal dimensions.

The flexible protection element 106 includes a metal foil element 164 and has a front surface 290 (or face 290) that is imprinted or embossed with a pattern 292. As illustrated in FIG. 35, the pattern 292 comprises a honeycomb structure having a plurality of cells 294 (or pattern elements 294). Each cell 294 has a depth that corresponds to the thickness of the metal foil element 164 and, hence, the flexible protection element 106. Thus, according to this example embodiment, an acceptable depth for each cell 294 is 0.2 millimeters for a metal foil element 164 having a thickness of 0.2 millimeters. Also, the pattern 292 and cells 294 are sized and arranged to repeat the pattern 292 within a distance referred to as a mesh width. In accordance with this example embodiment, the mesh width comprises 10 millimeters, meaning that the pattern 292 and cells 294 repeat themselves every 10 millimeters.

While this example embodiment has been described with reference to a flexible protection element 106 having a honeycomb pattern 292, it should be understood and appreciated that the flexible protection element 106 may, in other example embodiments, have other types of patterns 292 that are formed with linear, non-linear, specifically-shaped, and arbitrarily-shaped elements, alone or in combination, and be formed with different mesh widths. For example and not limitation, the flexible protection element 106 of another example embodiment may have patterns 292 including lines, arcs, ellipses, polygons, or other geometric and non-geometric elements. It should also be understood and appreciated that the flexible protection element 106 of other example embodiments may have patterns 292 made by methods other than imprinting or embossing such as, for example but not limitation, molding, stamping, surface printing, or surface etching. Additionally, it should be understood and appreciated that the flexible protection element 106 of other example embodiments may have patterns 292 formed by texturing of the element's front and/or back surfaces including, absent limitation, by the addition and/or removal of a material(s) to the front and/or back surfaces of the flexible protection element 106, or by the addition and/or removal, partially or entirely, of a coating, film, or other material(s) applied to the front and/or back surfaces of the flexible protection element 106. In addition, it should be understood and appreciated that while the flexible protection element 106 has been described with reference to FIG. 35 as being formed by a single layer of fire resistant material, the flexible protection element 106 may also be formed in other example embodiments using any of the materials and according to any of the structures (including, without limitation, the multi-layer structures) for flexible protection elements 106 described, or not described, herein.

FIG. 36 displays a schematic, partial, front elevational view of a smoke or fire protection device 100 in accordance with an example embodiment. The smoke or fire protection device 100 is substantially similar to the smoke or fire protection device 100 of the example embodiment illustrated by FIG. 6, but includes a flexible protection element 106 having a multi-layer structure in which a metal foil element 164 is interposed, or sandwiched, between a first layer 296 formed of a first wire mesh element 298A and a second layer 300 formed of a second wire mesh element 298B. In FIG. 36, the first layer 296 and metal foil element 164 near the corner of the flexible protection element 106 formed between longitudinal edge 114A and lateral edge 112B are peeled away to expose the multi-layer structure and for clarity. While not required, one or more of the metal foil element 164, first wire mesh element 298A, or second wire mesh element 298B may be connected together such as by contact welding. According to this and other example embodiments herein, the wire mesh elements 298 are manufactured from the same, or a similar, material as that of the metal foil element 164 including, but not limited to, an austenitic steel like, or similar to, the steels described above in the description of FIG. 17.

The flexible protection element 106 comprises a plurality of elongate strips 302 that extend in a lateral direction beyond lateral edges 112A, 112B and into respective first and second lead tracks 110A, 110B to aid in guiding the flexible protection element 106 during reconfiguring of the device 100 between a storage arrangement and protection arrangement. The elongate strips 302 are secured to the flexible protection element 106 by clamping using elongate clamping members 232 (not shown) and methods similar to those described above with reference to FIGS. 23 and 25. Each elongate strip 302 is positioned at a distance (d) relative to the immediately preceding and succeeding elongate ships 302 in the longitudinal direction. A distance (d) acceptable in accordance with this example embodiment, includes fifty (50) centimeters. Alternatively, since the multi-layer structure of the flexible protection element 106 comprises a metal foil element 164 and wire mesh elements 298A, 298B, the elongate strips 302 may be welded, in other example embodiments, to the flexible protection element 106 in lieu of being clamped to the flexible protection element 106 using elongate clamping members 232. In still other example embodiments, the flexible protection element 106 comprises elongate strips 302 that are present in addition to elongate clamping members 232.

Advantageously, the first and second wire mesh elements 298A, 298B generally have a higher tear resistance than the metal foil element 164. Typically, if the metal foil element 164 is hit by a water jet at a particular location, the metal foil element 164 will yield, bulge and possibly tear at the location. However, when reinforced and supported with an adjacent wire mesh element 298 as in this and other example embodiments, the notch stress at the base of the tear is small and the tear in the metal foil element 298 does not spread.

It should be understood and appreciated that while the flexible protection element 106 has been described with reference to FIG. 36 as being formed with wire mesh elements 298A, 298B, the flexible protection element 106 may alternatively be formed by substituting elements made from fire resistant materials, described or not described herein, for one or both of the wire mesh elements 298A, 298B. Also, it should be understood and appreciated that while the flexible protection element 106 has been described as comprising a particular multi-layer structure, the flexible protection element 106 may alternatively be formed using any of the materials and according to any of the structures (including, without limitation, the single and multi-layer structures) for flexible protection elements 106 described, or not described, herein.

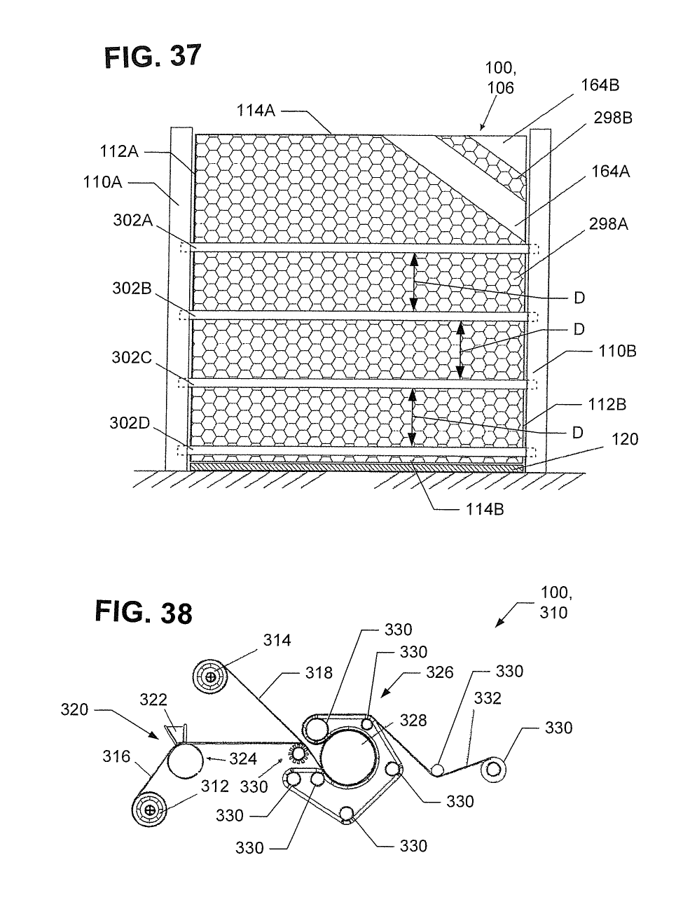

FIG. 37 displays a schematic, partial, front elevational view of a smoke or fire protection device 100 in accordance with an example embodiment. The smoke or fire protection device 100 is substantially similar to the smoke or fire protection device 100 of the example embodiments shown in FIGS. 6 and 36, but includes a flexible protection element 106 having a multi-layer structure including a first wire mesh element 298A, a first metal foil element 164A, a second wire mesh element 298B, and a second metal foil element 164B. In FIG. 37, the layers are shown peeled away near the corner of the flexible protection element 106 formed between longitudinal edge 114A and lateral edge 112B to expose the multi-layer structure and for clarity. As seen in FIG. 37, the first metal foil element 164A is positioned between the first wire mesh element 298A and the second wire mesh element 298B such that the second wire mesh element 298B is positioned between the first metal foil element 164A and the second metal foil element 164B. The first and second metal foil elements 164A, 164B may be imprinted or embossed with a pattern 292 similar to the metal foil element 164 described above with respect to FIG. 35 such that the first and second wire mesh elements 298A, 298B are arranged and reside in the depressions defined by the pattern 292 in the first and second metal foil elements 164A, 164B.

Similar to the flexible protection element 106 of FIG. 36, the flexible protection element 106 comprises a plurality of elongate strips 302 that extend in a lateral direction beyond lateral edges 112A, 112B and into respective first and second lead tracks 110A, 110B to aid in guiding the flexible protection element 106 during reconfiguration of the device 100 between a storage arrangement and protection arrangement. The elongate strips 302 are secured to the flexible protection element 106 by clamping using elongate clamping members 232 (not shown) and methods similar to those described above with reference to FIGS. 23 and 25. Each elongate strip 302 is positioned at a distance (d) relative to the immediately preceding and succeeding elongate strips 302 in the longitudinal direction. A distance (d) acceptable in accordance with this example embodiment, includes fifty centimeters (50 cm). Alternatively, since the multi-layer structure of the flexible protection element 106 comprises metal foil elements 164A, 164B and wire mesh elements 298A, 298B, the elongate strips 302 may be welded, in other example embodiments, to the flexible protection element 106 in lieu of being clamped to the flexible protection element 106 using elongate clamping members 232. In still other example embodiments, the flexible protection element 106 comprises elongate strips 302 that are present in addition to elongate clamping members 232.

In an alternative example embodiment, the layers of the multi-layer structure may be arranged in a different order in which the first and second metal foil elements 164A, 164B are disposed immediately adjacent one another back-to-back with the first wire mesh element 298A adjacent the first metal foil element 164A and the second wire mesh element 298B adjacent the second metal foil element 164B. Also, in another alternative example embodiment, the smoke or fire protection device 100 further comprises a second winding shaft 108 that enables the first wire mesh element 298A and first metal foil element 164A to be wound around the first winding shaft 108A and the second wire mesh element 298B and second metal foil element 164B to be around the second winding shaft 108B when the device 100 is in a storage arrangement. By using two winding shafts 108, the first and second metal foil elements 164A, 164B do not slip or shift relative to one another during winding about the winding shafts 108 as might occur if the first and second metal foil elements 164A, 164B were wound on a single winding shaft 108.

It should be understood and appreciated that while the flexible protection element 106 has been described with reference to FIG. 37 as being formed with wire mesh elements 298A, 298B, the flexible protection element 106 may alternatively be formed by substituting elements made from fire resistant materials, described or not described herein, for one or both of the wire mesh elements 298A, 298B. Also, it should be understood and appreciated that while the flexible protection element 106 has been described as comprising a particular multi-layer structure, the flexible protection element 106 may alternatively be formed using any of the materials and according to any of the structures (including, without limitation, the single and multi-layer structures) for flexible protection elements 106 described, or not described, herein.

FIG. 38 displays a schematic, partial diagram of a device 310 for manufacturing a multi-layer material for use in making a flexible protection element 106 in accordance with an example embodiment. As seen in FIG. 38, the device 310 comprises a first drum 312 and a second drum 314 offset at a distance relative to the first drum 312. A metal foil 316 is arranged around the first drum 312. A woven fabric 318 made from a fire resistant material is arranged around the second drum 314. The device 310 includes a coating unit 320 having a dispensing device 322 and a roller 324 for applying an adhesive coating. Additionally, the device 310 includes a connecting unit 326 having a heated cylinder 328 and a plurality of rollers 330 for applying a fire resistant material to the metal foil.

In operation, the metal foil 316 spools off of the first drum 312 and is directed toward the coating unit 320. While traveling through the coating unit 320, a paste-like adhesive is dispensed and applied to the metal foil by the dispensing device 322 and roller 324. The adhesive-covered metal foil 316 exits the coating unit 320 and is directed into the connecting unit 326. Concurrently, the woven fabric 318 is spooled off of the second drum 314 and into the connecting unit 326. Within the connecting unit 326, the adhesive-coated metal foil 316 and woven fabric 318 travel in contact and side-by-side around the heated cylinder 328 which activates the adhesive, causing the metal foil 316 and fire resistant woven fabric 318 to become securely connected together. The coupled metal foil and fire resistant woven fabric 332 comprises a dimensionally-stable, textile structure or composite material from which a flexible protection element 106 may be made.

If, for a particular application, the flexible protection element 106 requires the inclusion of a fire resistant knitted fabric element, the device 310 (or a similarly configured second device) may be used in a second pass similar to the first pass described above, to apply a knitted fabric layer to the already produced composite material. In such case, the composite material 322 from the first pass is loaded onto the first drum 312 and a fire resistant knitted fabric is loaded onto the second drum 314. Once loaded, the composite material 322 spools off of the first drum 312 and passes through the coating unit 320 where similar adhesive is applied and the adhesive coated composite material 322 is directed into the connecting unit 326. Concurrently, the kitted fabric is spooled off of the second drum 314 and into the connecting unit 326. Inside the connecting unit 326, the adhesive-coated composite material 322 and the knitted fabric come into contact and travel around the heated cylinder 328. The adhesive is activated by the heated cylinder 328 and the knitted fabric becomes secured to the composite material 322 to form a new composite material including a woven fabric, metal foil, and knitted fabric that may be used to produce a flexible protection element 106.

It should be understood and appreciated that the device 310 may be used to produce many different multi-layer materials that may be used in the manufacture of flexible protection elements 106 by loading the device 310 with desired materials and making multiple passes through the device 310 in an appropriate sequence to form suitable composite materials having the desired materials for particular applications.

### Lead Guide

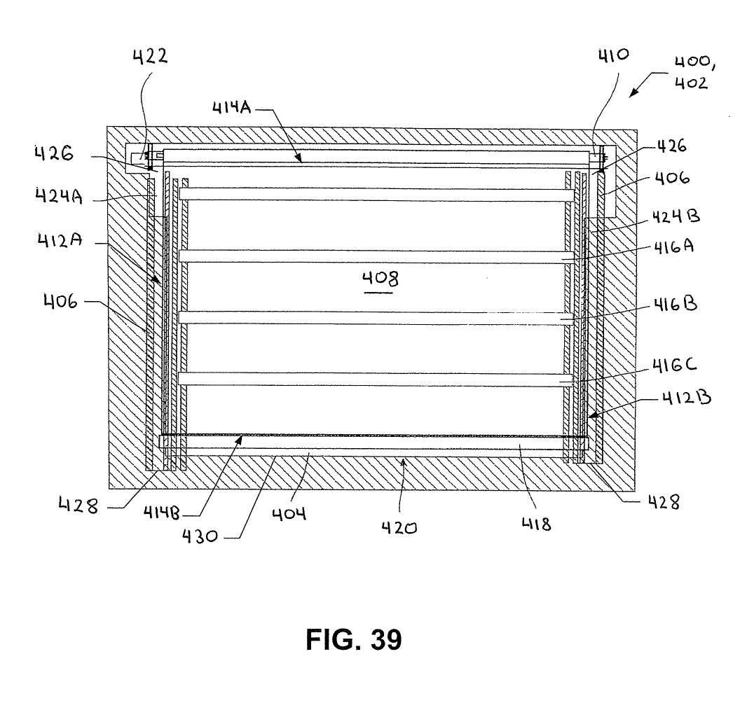

FIG. 39 displays a schematic, front, elevational view of a lead guide 400 for use with, or as a component part of, a smoke or fire protection device 402 in accordance with an example embodiment. The smoke or fire protection device 402 enables substantial sealing of an opening 404 in a building structure and limiting of the spread of fire and smoke through the opening 404. The smoke or fire protection device 402 is adapted for secure connection to a wall 406 relative to the opening 404 and is configurable in a first configuration that permits ingress and egress through the opening 404 when no fire or smoke exists. The device 402 is also configurable in a second configuration in which the device 402 significantly limits or prevents the spread of fire and smoke through the opening 404 during a fire. It should be noted that in FIG. 39, the cross-hatching is present to improve clarity and the differentiation of the various components of the lead guide 400 and the smoke or fire protection device 402, and does not, necessarily, signify a section through an object.

Generally, the tire and smoke protection device 402 comprises a flexible protection element 408 and a winding shaft 410 about and onto which the flexible protection element 408 is fully-wound (and, hence, fully-refracted) when the device 402 is configured in the storage arrangement so as not to occlude the opening 404. Conversely, the flexible element 408 is substantially fully-unwound from the winding shaft 410 when the device 402 is configured in the fully-deployed configuration so that the flexible protection element 408 fully occludes the opening 404. Thus, the flexible protection element 408 is selectively configurable to occlude or not occlude the opening 404.

The flexible protection element 408 includes a sheet-like member that is relatively thin in thickness as compared the lateral and longitudinal dimensions thereof. The flexible protection element 408 may comprise a single layer of material, multiple layers of the same or different materials, and/or have adjoining portions comprising single or multiple layers of materials that are manufactured and arranged in various configurations to provide structural strength, stability, and resistance to forces applied during or shortly after exposure to high temperatures such as those that may be encountered with a fire. Typically, the flexible protection element 408 is manufactured using one or more fire resistant materials, including, without limitation, lire resistant woven and knitted fabric materials, metal foil materials, intumescent materials, and/or wire mesh materials. Possible different constructions of the flexible protection element 408 are described more fully above and in U.S. patent application Ser. No. 13/738,431.

The flexible protection element 408 has opposed first and second lateral edges 412A, 412B that extend in the longitudinal direction, and has opposed first and second longitudinal edges 414A, 414B that extend in the lateral direction. The first longitudinal edge 414A is connected to the winding shaft 410 to facilitate winding of the flexible protection element 408 onto and about the winding shaft 410 and unwinding of the flexible protection element 408 off of and from the winding shaft 410, as appropriate, during reconfiguration of the device 402 between the storage and protection arrangements. The flexible protection element 408 also sometimes comprises one or more transverse strips 416, with each transverse strip 416 being offset from the immediately preceding and succeeding transverse strips 416 in the longitudinal direction. Each transverse strip 416 is connected to the material of the flexible protection element 408 and extends beyond the element's lateral edges 412 such that each of the strip's ends is received respectively within the lead tracks 424 described herein. To stabilize the surface area of the flexible protection element 408, it is recommended that the flexible protection element 408 include at least one and, perhaps, a few transverse strips 416. Each transverse strip 416 may or may not comprise a clamping member similar to those described above and in U.S. patent application Ser. No. 13/738,431.

Additionally, in the example embodiment, the flexible protection element 408 may comprise a sealing lip 418 attached at the element's second longitudinal edge 414B. The sealing lip 418 extends laterally along longitudinal edge 414B at least between the element's lateral edges 412 and is sufficiently heavy as to maintain the flexible protection element 408 pulled taut when the device 402 is not in the storage arrangement. When the device 402 is configured in the protection arrangement, the sealing lip 418 resides at and in contact with the foot 420 of the opening 404.

The smoke or fire protection device 402 also generally comprises a winding shaft motor 422 mechanically connected to the winding shaft 410 that is operable to rotate the winding shaft 410 in order to retract and wind the flexible protection element 408 onto the winding shaft 410, or to extend and unwind the flexible protection element 408 from the winding shaft 410. It should also be understood and appreciated that, the flexible protection element 408 is not wound about a winding shaft 410, but is instead folded or gathered when in the storage arrangement. When folded, the flexible protection element 408 always bends at the same bend locations. Conversely, when the flexible protection element 408 is gathered, bending occurs at random bend locations.

The lead guide 400 of the example embodiment comprises a structure that is configured for cooperative operation with the above described fire and protection device 402 or, potentially, with other similar devices having similar flexible protection elements 408 to direct and guide a flexible protection element 408 during reconfiguration between a storage arrangement and a protection arrangement and to limit the spread of fire and smoke around the flexible protection element 408. Additionally, the lead guide 400 provides structural support for the flexible protection element 408 (which is generally not self-supporting) and resistance to forces applied to the flexible protection element 408 during a fire.

In accordance with the example embodiment, the lead guide 400 comprises a first lead track 424A and an opposed second lead track 424B that are secured to the wall 406 of a building at respectively opposed locations relative to, in or near the opening 404. To integrate the lead guide 400 into the building as unobtrusively as possible, the lead tracks 424 are often mounted to the wall 406 or embedded within the wall 406 surrounding and forming the opening 404 through which the spread of fire and smoke is to be limited by the device 402. The lead tracks 424 have first ends 426 and distant second ends 428 such that the lead tracks 424 have a generally elongate shape. The lead tracks 424 are mounted with their first ends 426 located nearest the device's winding shaft 410 and the second ends 428 nearest the base 430 of the opening 404.

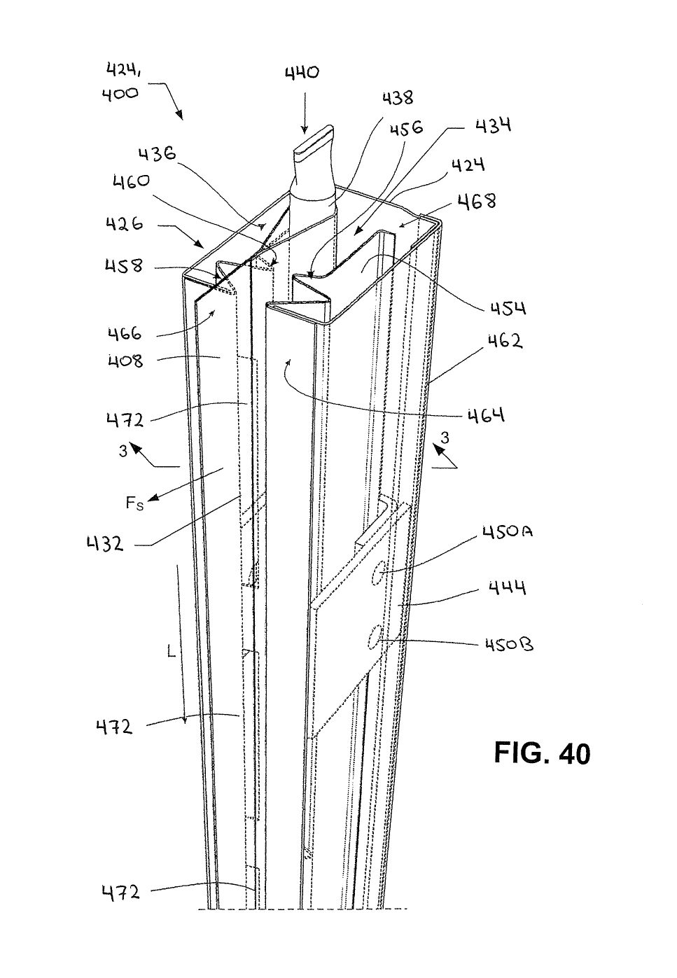

The lead tracks 424 define respective elongate openings 432 (see FIG. 40) and elongate cavities 434 (see FIG. 40) therein extending substantially between their first and second ends 426, 428 for respectively receiving the opposed lateral edges 412A, 412B of the flexible protection element 408. During winding or unwinding of the flexible protection element 408 onto/from the winding shaft 410 as the device 402 is reconfigured between the storage arrangement and fully-deployed configuration, the lateral edges 412 of the flexible protection element 408 move respectively within and relative to the elongate openings 432 and elongate cavities 434 in a substantially longitudinal direction. In the protection arrangement, the lateral edges 412 of the flexible protection element 408 reside within the elongate openings 432 and elongate cavities 434. The elongate openings 432 are sized and shaped in concert with the flexible protection element 408 such that the elongate openings 432 provide slight gaps having sufficient clearance for the lateral edges 412 of the flexible protection element 408 to slide within and relative to the respective tracks 424, but do not provide gaps with the flexible protection element 408 of sufficient size for an appreciable amount of fire and/or smoke to pass through. To limit the spread of fire and smoke, the lead tracks 424 employ an undercut or labyrinth construction, but it should be understood and appreciated that other structures and methods may be used. The lead tracks 424 are described in greater detail herein, but are generally manufactured from a plurality of components made from one or more materials that are appropriately selected and capable of withstanding the high temperatures produced by fires absent significant yielding, deflection, or deformation.

As described above, the lateral edges 412 of the flexible protection element 408 are respectively received by the lead tracks 424 during reconfiguration of the device 402 between the storage arrangement and protection arrangement and while the device 402 remains in the storage arrangement. The flexible protection element 408 has loops 436 (see FIG. 40) at each lateral edge 412 which are also respectively and similarly received by the lead tracks 424.

FIG. 40 displays a partial, schematic, perspective view of a lead tracks 424 of the lead guide 400 in accordance with the example embodiment. Lead track 424A is constructed as a mirror image of lead track 424B and, therefore, the description of a lead track 424 herein applies, generally, to both lead tracks 424A, 424B. Each lead track 424 comprises an elongate lead member 438 that is received by and within loops 436 of the flexible protection element 408. The lead member 438 extends in the longitudinal direction substantially between the lead guide's first and second ends 426, 428 and has a free, first end 440 nearest winding shaft 408 and a second end 442 resting on base 430. Together with each loop 436, the lead member 438 generally forms a lateral keder. A lead member 438, acceptable in accordance with the example embodiment, includes an elongate rod. Also, in an alternative example embodiment, the lead member 438 may be fixed at both ends.

Each lead track 424 comprises an outer frame member 444 that is secured to (for example, by fasteners such as bolts or screws) and/or embedded into the wall 406 of a building and transfers any forces exerted by the flexible protection element 408 on the lead track 424 to the building. The outer frame member 444 is designed to act like a brace to which the inner guiding members 454, 458 are fixed and, hence, includes a brace member 446 and a connecting member 448. The outer frame member 444 defines two threaded holes 450A, 450B. A fastener (not shown) is threadably engaged by and within the first hole 450A, in order to connect the brace member 446 of the outer frame member 444 with the connecting member 448. Similarly, a fastener (not shown) is threadably engaged by and within the second hole 450B, which fixes an outer frame plate 462 to the connecting member 448. The outer frame member 444 defines an elongated slot 452 that receives a fastener (not shown) through which the lead track 424 is secured to the building's wall 406.

Each lead track 424 also comprises a first inner guiding member 454 formed, according to the example embodiment, by a profiled metal guide sheet. The metal guide sheet is prism-shaped, which means that the cross-section along a longitudinal axis (L) does not fundamentally change. The first inner guiding member 454 is bent in such a way that it forms a first protrusion 456. The lead member 438 is positioned relative to the first protrusion 456 in such a way that a tractive force (Fₛ) pulls the lead member 438 against the first protrusion 456. However, the lead member 438 cannot slide past the first protrusion 456. Additionally, the lead track 424 comprises a second inner guiding member 458 from which a second protrusion 460 extends. According to the example embodiment, the second inner guiding member 458 is designed to be a mirror image of the first inner guiding member 454. Alternatively, in other embodiments, the second inner guiding member 458 is not a mirror image of the first inner guiding member 454. In addition, each lead track 424 comprises an outer frame plate 462 which is fixed to the outer frame member 444 and encloses the inner guiding members 454, 458. When the lead system 400 has been installed, the outer frame plate 462 is generally positioned with one side against or embedded in the wall 406. The inner guiding members 454, 458 may, alternatively, with the outer frame plate 462 form a single component. However, it is more advantageous if the inner guiding members 454, 458 are separate components, as in the example embodiment, which are connected with the outer frame plate 462.

In accordance with the example embodiment, the inner guiding members 454, 458 are only connected with the outer frame plate 462 along their respective first long sides 464, 466. The first inner guiding member 454 has a second long side 468 opposite the first long side 464, which forms a free end, meaning advantageously that the second long side 468 is not fixed to another component and that may move relative to the outer frame member 444. The second inner guiding element 458 has a second long side 470 opposite the first long side 466, which also forms a free end such that the second long side 470 is beneficially not fixed to another component and able to move relative to the outer frame member 444. By virtue of the inner guiding members 454, 458 having free ends, the outer frame member 444 can warp during a fire and deform for a substantial period of time without the resulting forces excessively deforming the inner guiding members 454, 458.

Notably, the inner guiding members 454, 458 are generally more giving than the outer frame of the lead track 424. In other words, the inner guiding members 454, 458 yield to an external force whereas the other components of the lead guide 400 do not. This means that the inner guiding members 454, 458 become deformed when a force acts upon the flexible protection element 408. For example, when a water jet such as that from a fire hose is aimed at the flexible protection element 408 within the scope of the Hose Stream Test, the flexible protection element 408 bulges out and absorbs the pressure of the water jet. As a result, the inner guiding members 454, 458 become deformed and allow the flexible protection element 408 to bulge out even further. In contrast, the outer frame of the lead track 424 remains substantially undistorted.

Further, it is advantageous if the inner guiding members 454, 458 act as a spring. As described above, the inner guiding members 454, 458 are formed from metal guide sheets that are fixed only along their respective first long sides 464, 466 to the outer frame plate 462 and have respective protrusions 456, 460 that are engaged by corresponding lead members 438. Since metal guide sheets having relatively high dimensional stability in the event of fire are easy to produce, the inner guiding members 454, 458 may be manufactured to also have relatively high dimensional stability. However, even though the inner guide members 454, 458 have relatively high dimensional stability, the inner guide members 454, 458 may still deform or distort elastically if the flexible protection element 408 bulges out in response to the application of a force to the flexible protection element 408. During such deformation or distortion, the protrusions 456, 460 move relative to the outer frame member 444 which is securely connected to the wall 406 of the building. Since the inner guiding members 454, 458 are fixed only along their respective first long sides 464, 466, such elastic deformation or distortion occurs more readily.

The connections between the inner guiding members 454, 458 and the outer frame plate 462, which may be made, for example, using welding points, solder points, screws, rivets, adhesive or similar, are formed in such a way that the connections can safely bear the forces that occur during normal operation. However, it is beneficial if the connections are designed to be so weak that they come loose in the event of a fire. Generally, this causes the outer frame plate 462 to become very distorted, as a result of the heat from the fire. Since the inner guiding members 454, 458 are better protected against heat, they become less distorted.

When the connections come loose, no forces are transferred from the outer frame plate 462 to the inner guiding members 454, 458. This means that the inner guiding members 454, 458 become less distorted and the lead member 438 remains securely in place. In other words, the lead member 438 cannot be pulled or torn out of the lead track 424 if the outer frame plate 462 becomes very warped.

The second inner guiding member 458 (which may be omitted from a lead track 424 if a protrusion exists elsewhere which can support the lead member 438) defines several recesses 472 arranged in such a way that the flexible protection element 408 does' not come into contact with them and so does not cause additional friction near the element's edges. The recesses 472 weaken the second inner guiding member 458, so that the element distorts more easily when the tractive force (Fₛ) is exerted on the flexible protection element 408. Furthermore, any distortions of the outer frame plate 462 do not cause the inner guiding member 454 to also distort in the area engaged by the lead member 438. The recesses 472 also stretch for the longitudinal length along the longitudinal axis (L) on which the inner guiding member 454 is connected with the outer frame member 444. This leads to an S-shaped transfer of forces from the lead member 438 via the inner guiding members 454, 458 and the outer frame member 444 to the building and, therefore, to a higher flexibility.

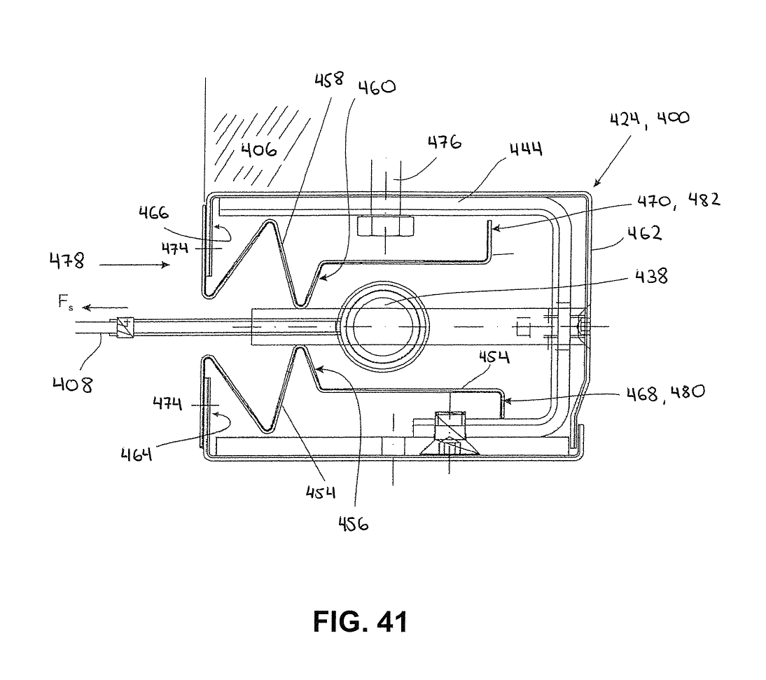

FIG. 41 displays a schematic, cross-sectional view of the lead guide of FIG. 40 taken along lines 3-3 thereof. It should be recognized that the inner guiding members 454, 458 are connected with the outer frame plate 462 by means of point-to-point connections 474 in the form of connection points. According to the example embodiment, the point-to-point connections 474 are formed from a non-heat resistant material, such as plastic.

The outer frame member 444 is connected with the wall 406 by a fastener 476 such as, for example and not limitation, a screw. It should be recognized that an end face 478 of the lead track 424 is flush with the wall 406. Of course, it is also possible that the end face 478 protrudes above the wall 406 or is offset backwards. The outer frame plate 462 is located between the wall 406 and the outer frame member 444 and is, thus, connected with the wall 406.

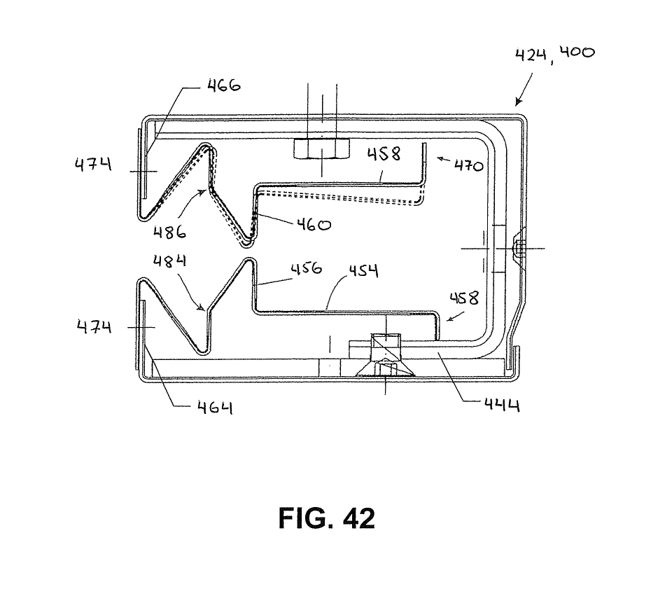

As seen in FIG. 41, the lead member 438 has no contact with the protrusions 456, 460 if there is no tractive force acting on the flexible protection element 408. The inner guiding members 454, 458 each have a free end 480, 482 that is situated opposite to the end that is connected with the outer frame plate 462. The free ends 480, 482 may be moved freely relative to the outer frame member 444 and the outer frame plate 462. If a tractive force (Fs) is exerted on the flexible protection element 408, the lead member 438 presses onto the first and second protrusions 456, 460. As a result, the inner guiding members 454, 458 become distorted, as is depicted by the dotted line in FIG. 42.

FIG. 42 displays a schematic, cross-sectional view of a lead track 424, according to an alternate example embodiment, taken along similar lines as the cross-section of FIG. 41. According to the alternate example embodiment, the inner guiding members 454, 458 are additionally bent at the bending points 484, 486, causing the inner guiding members 454, 458 to become even more giving and enabling increased stretching and bulging of the flexible protection element 408. In other words, the additional bending points weaken the inner guiding members 454, 458.

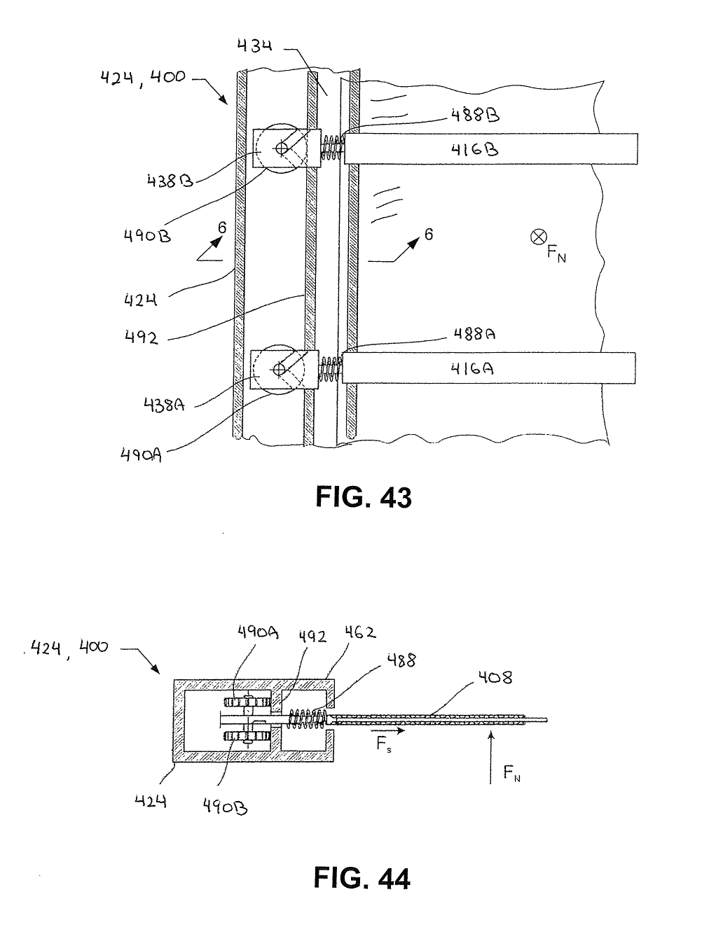

FIG. 43 displays a partial, schematic, cross-sectional view of a lead track 424, according to an alternate example embodiment, showing the interaction between the lead track 424 and transverse strips 416 of a flexible protection element 408. As seen in FIG. 43, the flexible protection element 408 comprises a plurality of transverse strips 416. The lead guide 400 further comprises one or more expandable/compressible members 488 such that each transverse strip 416 of the flexible protection element 408 extends into a lead track 424 and is connected to the lead guide 400 via an expandable/compressible member 488 arranged proximate the lead track 424. When a force acts upon the transverse strips 416 such as when a water jet strikes the flexible protection element 408 during a fire or during the Hose Stream Test, the expandable/compressible members 488 stretch even though the transverse strips 416 do not generally stretch. By virtue of the expandable/compressible members 488 stretching, the flexible protection element 408 (to which the transverse strips 416 are attached) is permitted to stretch and bulge out, thereby resisting and withstanding the force.

Also, as seen in FIG. 43, the lead track 424 comprises a plurality of rollers 490 and an internal wall 492 such that the rollers 490 are guided along and roll in contact with the internal wall 492. As described herein, the internal wall is formed by a protrusion. During reconfiguration of the smoke or fire protection device 402 between the storage and protection arrangements, the transverse strips 416 move in conceit with the remainder of the flexible protection element 408. Through rolling of the rollers 490 along the internal wall 492 during such reconfiguration, movement of the transverse strips 416 is aided.

It should be understood and appreciated that while FIG. 43 displays only one lead track 424, the other opposing lead track 424 is substantially a mirror image of the displayed lead track 424 having a similar internal wall 492. Additionally, it should be understood and appreciated that the lead guide 400 further comprises one or more expandable/compressible members 488 and one or more rollers 490 that are connected and interact with the respective transverse strips 416 in the other opposing lead track 424 in a substantially similar manner.

In addition, it should be recognized that the elongate cavities 434 of the lead track 424 respectively receive the lateral edges 412 of the flexible protection element 408 when the device 402 is in the protection arrangement or transitioning between the storage and protection arrangements. Because the expandable/compressible elements 488 and rollers 490 are similarly present within the lead tracks 424 at similar times, the expandable/compressible elements 488 and rollers 490 are protected from view and the impact of the heat of a fire by the outer frame plates 462 of the lead tracks 424.

In a similar alternate embodiment, the flexible protection element 408 may comprise at least two layers including, for example and not limitation, fire resistant material. The expandable/compressible elements 488 and/or rollers 490 may be arranged within the layers to protect the expandable/compressible elements 488 and/or rollers 490 from heat as well as from mechanical forces.

FIG. 44 displays a partial, schematic, cross-sectional view of the lead guide of FIG. 43 taken along lines 6-6. As seen FIG. 44, each expandable/compressible member 488 includes, for example, a spring which stretches when a tractive force (Fₛ) is exerted on the flexible protection element 408. The tractive force (Fₛ) occurs when a normal force (F_{N}) which acts upon the flexible protection element 408 in the normal direction (e.g., in the direction of the thickness of the flexible protection element 408), is exerted. For example, the normal force (F_{N}) occurs when a jet of fire extinguishing water hits the flexible protection element 408. Due to the fact that the expandable/compressible element 488 is flexible, the constraining force is reduced, in the form of the tractive force (Fₛ) that is acting upon the flexible protection element 408. It is particularly advantageous if the expandable/compressible element 488 comprises a compression spring. However, in other alternative example embodiments, the expandable/compressible element 488 may comprise a spiral spring, conical spring, leaf spring, plate spring or an evolute spring.

In addition, it should be noted that the expandable/compressible member 488 does not have to include a spring. For example, it is also possible that the expandable/compressible member 488 is not heat resistant. In this way, it is possible for the transverse strips 416 to comprise two parts which slide against and relative to one another, meaning that these two parts are guided together. For example, each of the parts comprises a protrusion that is guided into a slot of the respective other part. The slot is filled with a thermally instable element (e.g. a plastic element) so that the two parts cannot move against one another during normal operation. In the event of a fire, the plastic melts or burns and leaves the slot open. The two parts can then slide against one another.

In use, when the smoke or fire protection device 402 is reconfigured from the storage arrangement to the protection arrangement, the loops 436 at the lateral edges 412 of the flexible protection element 408 are threaded onto the respective lead members 438 of the lead guide 400 such that the loops 436 respectively receive the lead members 438 therein. To do so, the flexible protection element 408 is pulled over fixed discharge edges that are respectively arranged near the first ends 440 of the lead members 438. The fixed discharge edges and lead members 438 ensure that the flexible protection element 408 always enters and exits the lead guide 400 and the lead tracks 424 thereof at the same position relative to the first ends 440 of the lead members 438.

During or after deployment of the flexible protection element 408 into the protection arrangement, the lead members 438 are connected with the flexible protection element 408 and produce the forces that keep the flexible protection element 408 in place, even while external forces are acting on the flexible protection element 408. If the flexible protection element 408 is subsequently retracted into the storage arrangement, the lead members 438 remain in place and the loops 436 of the flexible protection element 408 slide along and relative to the respective lead members 438 in the longitudinal direction toward the elements' first ends 440. The flexible protection element 408 is wound onto the winding shaft 410 as the loops 436 of the flexible protection element 408 slide along and become unthreaded from the lead members 438.

It should be understood and appreciated that each of the lead members 438 may, in an alternative example embodiment, comprise a roll or guide shoe that slides onto/off of the lead members 438, as appropriate, when the flexible protection element 408 is reconfigured between the storage and protection arrangements. Regardless of their configuration, the lead members 438 generally hold the flexible protection element 408 relatively still in the lateral direction and are supported by the inner guiding members 454, 458. The inner guiding members 454, 458 direct and transmit the forces acting on the flexible protection element 408 to the building's wall 406 via the outer frame members 444 of the lead tracks 424.

Various embodiments disclosed herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to the provided description without departing from the scope or spirit of the disclosure.

Other embodiments, uses and features of the present disclosure will be apparent to those skilled in the art from consideration of the specification and practice of the inventive concepts disclosed herein. The specification and drawings should be considered exemplary only, and the scope of the disclosure is accordingly intended to be limited only by the following claims.

What is claimed is:

1. A fire or smoke protection device for limiting the spread of fire and smoke through an opening in a wall of a building comprising:
a flexible protection element configured to retract into a storage arrangement relative to said opening, and to deploy into a protection arrangement to seal the opening and limit the spread of fire and smoke through said opening;
a sealing lip attached to said flexible protection element and arranged at a foot of said opening such that said flexible protection element is situated on a ground when deployed to said protection arrangement; and
a flexible ballast arranged on said sealing lip to securely seal said flexible protection element relative to said ground and an underside of said flexible protection element.

2. The fire or smoke protection device according to claim 1, wherein said sealing lip is made of a flexible and fire-resistant material.

3. The fire or smoke protection device according to claim 1, wherein said flexible ballast is a chain.

4. The fire or smoke protection device according to claim 1 further comprising:
a bulge formed at said foot of said flexible protection element and above said sealing lip; and
a rod arranged in said bulge to press onto said sealing lip when said flexible protective element is deployed into said protection arrangement.

5. The fire or smoke protection device according to claim 1, wherein said sealing lip is made of an intumescent material.

6. The fire or smoke protection device according to claim 1 further comprising:
a rod arranged at a foot of said opening; and
a locking device to lock said rod in an activated position when said flexible protection element is deployed into said protection arrangement.

7. The fire or smoke protection device according to claim 6 further comprising:
a lead guide with one or more tracks,
wherein said rod is guided into said lead guide.

8. The fire or smoke protection device according to claim 6, wherein said locking device includes:
a bar to restrict freedom of movement of said rod when in said activated position, and to release said rod when in an unlocked position; and
a heat-activated element configured to position said bar when in said activated position if an activation temperature is exceeded.

9. The fire or smoke protection device according to claim 8, wherein said heat-activated element includes:
a spring to release said bar from said unlocked position and to position said bar in said activated position when said activation temperature is exceeded.

10. The fire or smoke protection device according to claim 8, wherein said heat-activated element is made of an intumescent material that expands in an event of a fire and exerts a force on said bar.

11. The fire or smoke protection device according to claim 1, wherein the flexible protection element is formed by a multi-layer structure that includes a metal foil element sandwiched between two woven fabric elements, and wherein the multi-layer structure is surrounded in a lateral direction and a longitudinal direction by a single layer of a knitted fabric element.

12. The fire or smoke protection device according to claim 11, further comprising:
a segment of the knitted fabric element above the multi-layer structure formed with an overlap of material of the flexible protection element and held in position with seams having non-fire resistant thread.

13. The fire or smoke protection device according to claim 1, wherein the flexible protection element is constructed using seams between a fabric member and a metal foil member that are formed with stitching patterns.

14. The fire or smoke protection device according to claim 1, wherein the flexible protection element is manufactured with a metal foil element imprinted or embossed with a pattern.

15. The fire or smoke protection device according to claim 1, wherein the flexible protection element is formed from a plurality of traverse strips, and wherein each of the plurality of traverse strips is coupled to an adjacent traverse strip by a clamping member.

16. The fire or smoke protection device according to claim 1, further comprising:
a lead guide, the lead guide includes a pair of tracks for guiding the flexible protection element between the storage arrangement and the protection arrangement,
wherein the lead guide permits the flexible protection element to stretch and bulge when a force is applied to the flexible protection element.

17. A fire or smoke protection device for limiting the spread of fire and smoke through an opening in a wall of a building comprising:
a flexible protection element configured to retract into a storage arrangement relative to said opening, and to deploy into a protection arrangement to seal the opening and limit the spread of fire and smoke through said opening;
a rod arranged at a foot of said opening; and
a locking device to lock said rod in an activated position when said flexible protection element is deployed into said protection arrangement.

18. The fire or smoke protection device according to claim 17 further comprising:
a lead guide with one or more tracks,
wherein said rod is guided into said lead guide.

19. The fire or smoke protection device according to claim 17, wherein said locking device includes:
a bar to restrict freedom of movement of said rod when in said activated position, and to release said rod when in an unlocked position; and
a heat-activated element configured to position said bar when in said activated position if an activation temperature is exceeded.

20. The fire or smoke protection device according to claim 19, wherein said heat-activated element includes:
a spring to release said bar from said unlocked position and to position said bar in said activated position when said activation temperature is exceeded.

21. The fire or smoke protection device according to claim 19, wherein said heat-activated element is made of an intumescent material that expands in an event of a fire and exerts a force on said bar.

22. A fire or smoke protection device for limiting the spread of fire and smoke through an opening in a wall of a building comprising:
a flexible protection element configured to retract into a storage arrangement relative to said opening, and to deploy into a protection arrangement to seal the opening and limit the spread of fire and smoke through said opening;
a sealing lip attached to said flexible protection element and arranged at a foot of said opening such that said flexible protection element is situated on a ground when deployed to said protection arrangement;
a flexible ballast arranged on said sealing lip to securely seal said flexible protection element relative to said ground and an underside of said flexible protection element;
a rod arranged at a foot of said opening;
a locking device to lock said rod in an activated position when said flexible protection element is deployed into said protection arrangement; and
a lead guide, the lead guide includes a pair of tracks for guiding a flexible protection element between the storage arrangement and the protection arrangement,
wherein the lead guide permits the flexible protection element to stretch and bulge when a force is applied to the flexible protection element,
wherein the flexible protection element is formed from a plurality of traverse strips, and
wherein each of the plurality of traverse strips is coupled to an adjacent traverse strip by a clamping member.
